(19) United States
(12) Patent Application Publication
(10) Pub. No.: US 2009/0041245 A1
(43) Pub. Date: Feb. 12, 2009

(54) CONFIDENTIAL INFORMATION PROCESSING DEVICE,CONFIDENTIAL INFORMATION PROCESSING APPARATUS, AND CONFIDENTIAL INFORMATION PROCESSING METHOD

(75) Inventors: Yuishi TORISAKI, Hyogo (JP); Yusuke NEMOTO, Hyogo (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/187,594

(22) Filed: Aug. 7, 2008

(30) Foreign Application Priority Data
Aug. 10, 2007 (JP) 2007-210235

(51) Int. Cl. H04L 9/14; H04L 9/28

(52) U.S. Cl. 380/259; 380/255; 380/42

(57) ABSTRACT

A confidential information processing device performs a cryptographic operation on first input data and second input data. A first cryptographic operation circuit includes: a first register for holding first information; and a first cryptographic operation unit. A first pseudo-cryptographic operation circuit includes a second register for holding second information. A first arbitration circuit causes the first cryptographic operation unit to perform the cryptographic operation on the first input data using the first information held in the first register, when a cryptographic operation request for the first input data is made to the first cryptographic operation circuit, and causes the first cryptographic operation unit to perform the cryptographic operation on the second input data using the second information held in the second register, when a cryptographic operation request for the second input data is made to the first pseudo-cryptographic operation circuit.

### BACKGROUND OF THE INVENTION

(1) Field of the Invention

The present invention relates to a confidential information processing device, a confidential information processing apparatus, and a confidential information processing method. The present invention especially relates to a confidential information processing device that performs a cryptographic operation on a plurality of sets of data.

(2) Description of the Related Art

In recent years, transmission and reception of streams including moving picture data, audio data, and the like are performed between mobile phones, digital televisions, set-top boxes (STBs), and personal computers (PCs) by radio or via a network and the like. In such data transmission and reception, a technique for encrypting data to be transmitted is employed to enhance security. This being so, the above mobile phones, digital televisions, STBs, and PCs each include a confidential information processing device that decrypts encrypted data (hereafter referred to as “ciphertext data”) included in a stream or encrypts plaintext data included in a stream (hereafter, at least one of decryption and encryption is referred to as “cryptographic operation”).

There is a case where such a confidential information processing device is congested with input of a plurality of streams. For example, in a digital television or the like, when displaying two programs simultaneously or when recording one program while displaying another program, a plurality of streams are inputted in a confidential information processing device in a congestion state. When a plurality of streams are inputted in a congestion state, the confidential information processing device needs to perform a cryptographic operation on the plurality of streams in parallel, by switching between data included in the plurality of streams.

In view of this, a first confidential information processing device that performs a cryptographic operation on a plurality of streams using one cryptographic operation circuit is known (for example, see International Patent Publication WO01/052472 pamphlet, hereafter referred to as “Patent Reference 1”).

FIG. 1 shows a structure of the conventional first confidential information processing device described in Patent Reference 1.

The first confidential information processing device described in Patent Reference 1 is an encryption device, and includes a selector 54, an encryption unit 52, and a memory 55. The encryption unit 52 includes an exclusive-OR circuit 58 and an encryption module 51 that performs encryption using an encryption key K.

The selector 54, the exclusive-OR circuit 58, and the encryption module 51 form a feedback loop by feedback lines 65, 66, and 67. Ciphertext block data Ci generated as a result of encryption by the encryption module 51 is inputted again in the exclusive-OR circuit 58 by the feedback loop, and module input data Si is generated in the exclusive-OR circuit 58. The generated module input data Si is fed into the encryption module 51.

The memory 55 is arranged in parallel with the feedback line 65. The memory 55 includes a register 56 and a switch 57. The switch 57 controls whether the output of the encryption module 51 is inputted in the register 56 or ignored. The register 56 stores the ciphertext block data Ci passing through a terminal E of the switch 57. The ciphertext block data Ci stored in the register 56 is outputted to the selector 54.

According to the above structure, when switching to second data during processing of first data, the first confidential information processing device described in Patent Reference 1 stores a chain value (ciphertext block data Ci) of the first data in the register 56. When resuming the processing of the first data, the first confidential information processing device described in Patent Reference 1 uses the chain value stored in the register 56. In this way, the first confidential information processing device described in Patent Reference 1 can perform a cryptographic operation while switching data.

Moreover, the first confidential information processing device described in Patent Reference 1 can consecutively perform a cryptographic operation of a same algorithm for each block, by feedback-inputting a processing result of first data as second data.

In recent years, there is also a case where two cryptographic operations are performed on one set of data. Examples of this include when encrypting one set of data twice, and when decrypting one set of data and then encrypting the decrypted set of data.

In view of this, a second confidential information processing device that performs a concealment process and an integrity assurance process on one set of data is disclosed in Patent Reference 1. This conventional second confidential information processing device performs the concealment process and the integrity assurance process using one cryptographic operation circuit. The conventional second confidential information processing device includes a register for saving a chain value, as in the first confidential information processing device. The conventional second confidential information processing device reads a chain value of the concealment process held in a register when the concealment process starts, and stores a chain value generated by the concealment process in the register when the concealment process ends. The conventional second confidential information processing device also reads a chain value of the integrity assurance process held in a register when the integrity assurance process starts, and stores a chain value generated by the integrity assurance process in the register when the integrity assurance process ends. Thus, the conventional second confidential information processing device can perform two cryptographic operations on one set of data, using one cryptographic operation circuit.

However, in the first confidential information processing device described in Patent Reference 1, the number of sets of data that can be switched is limited by the number of registers. Likewise, in the second confidential information processing device described in Patent Reference 1, the number of cryptographic operations that can be executed on one set of data is limited by the number of registers. That is, the conventional confidential information processing devices have the following problem: increasing the number of sets of data that can be switched or increasing the number of cryptographic operations that can be executed on one set of data causes an increase in circuit area.

### SUMMARY OF THE INVENTION

The present invention has been developed to solve the above problem, and has an object of providing a confidential information processing device, a confidential information processing apparatus, and a confidential information processing method that can perform a cryptographic operation on a plurality of sets of data and also perform a plurality of cryptographic operations on one set of data, without an increase in circuit area.

To achieve the stated object, the confidential information processing device according to the present invention is a confidential information processing device that performs a cryptographic operation on first input data and second input data, the confidential information processing device including: a first cryptographic operation circuit; a first pseudo-cryptographic operation circuit; and a first arbitration circuit that arbitrates cryptographic operation requests made to the first cryptographic operation circuit and the first pseudo-cryptographic operation circuit, wherein the first cryptographic operation circuit includes: a first register that holds first information necessary for performing the cryptographic operation on the first input data; and a first cryptographic operation unit that performs the cryptographic operation, the first pseudo-cryptographic operation circuit includes a second register that holds second information necessary for performing the cryptographic operation on the second input data, the confidential information processing device further includes: a storage unit that holds the first information and the second information; and a control circuit that writes the first information and the second information held in the storage unit respectively into the first register and the second register, and saves the first information and the second information respectively held in the first register and the second register into the storage unit, and the first arbitration circuit: causes the first cryptographic operation unit to perform the cryptographic operation on the first input data using the first information held in the first register, when a cryptographic operation request for the first input data is made to the first cryptographic operation circuit; and causes the first cryptographic operation unit to perform the cryptographic operation on the second input data using the second information held in the second register, when a cryptographic operation request for the second input data is made to the first pseudo-cryptographic operation circuit.

According to this structure, information necessary for a cryptographic operation of each set of input data is held in the storage unit. In addition, information held in the first register and the second register can be saved into or restored from the storage unit, by means of the control circuit. This being so, each of the first register and the second register only needs to hold information necessary for a cryptographic operation of at least one set of input data. Therefore, in the confidential information processing device according to the present invention, the number of registers need not be increased even when the number of sets of data that can be switched or the number of cryptographic operations that can be executed on one set of data is increased. That is, the confidential information processing device according to the present invention can increase the number of sets of data between which a cryptographic operation can be switched or the number of cryptographic operations that can be executed on one set of data, without increasing a register circuit area. Hence the confidential information processing device according to the present invention can perform a cryptographic operation on a plurality of sets of data and also perform a plurality of cryptographic operations on one set of data, without an increase in circuit area.

Furthermore, the first cryptographic operation unit performs a cryptographic operation using information held in the first register or the second register. Accordingly, in the case of switching the cryptographic operation between the first input data and the second input data, the information saving and restoring between the storage unit and the first register or the second register does not need to be performed each time the data which is subject to the cryptographic operation is switched. As a result, the number of times the information saving and restoring is performed can be reduced. This enables the confidential information processing device according to the present invention to perform cryptographic operations at high speed.

Moreover, the first information may include at least one of a key, an initial value, and intermediate information of the cryptographic operation of the first input data, and the second information may include at least one of a key, an initial value, and intermediate information of the cryptographic operation of the second input data.

According to this structure, the confidential information processing device according to the present invention can perform a cryptographic operation on a plurality of sets of data, by switching information that includes at least one of a cryptographic operation key, initial value, and intermediate information. The confidential information processing device according to the present invention can also perform a plurality of cryptographic operations on one set of data, by switching information that includes at least one of a cryptographic operation key, initial value, and intermediate information.

Moreover, the control circuit may: save information held in the first register into the storage unit and write the first information held in the storage unit into the first register, when the cryptographic operation request for the first input data is made to the first cryptographic operation circuit and the first information is not held in the first register; and save information held in the second register into the storage unit and write the second information held in the storage unit into the second register, when the cryptographic operation request for the second input data is made to the first pseudo-cryptographic operation circuit and the second information is not held in the second register.

According to this structure, when information necessary for a cryptographic operation of input data is not held in the first register or the second register, the control circuit saves information held in the first register or the second register into the storage unit, and restores the necessary information held in the storage unit into the first register or the second register. As a result, the information corresponding to the input data is obtained in the first register or the second register. Thus, the first cryptographic operation unit can perform a cryptographic operation on a plurality of sets of input data, using information held in the first register and the second register.

Moreover, the confidential information processing device may further include: a first analysis circuit that extracts the first input data from a first stream, and incorporates first output data into the first stream, the first output data being a result of the cryptographic operation performed on the first input data by the first cryptographic operation unit; and a second analysis circuit that extracts the second input data from a second stream, and incorporates second output data into the second stream, the second output data being a result of the cryptographic operation performed on the second input data by the first cryptographic operation unit, wherein the first cryptographic operation unit performs the cryptographic operation on the first input data extracted by the first analysis circuit, using the first information held in the first register, and performs the cryptographic operation on the second input data extracted by the second analysis circuit, using the second information held in the second register.

According to this structure, the confidential information processing device according to the present invention can extract data of an arbitrary area from a stream and perform a cryptographic operation on the extracted data. Therefore, the confidential information processing device according to the present invention can easily support various cryptographic schemes.

Moreover, the second input data may be a result of the cryptographic operation performed on the first input data by the first cryptographic operation unit, wherein the first arbitration circuit causes the first cryptographic operation unit to perform the cryptographic operation on the first input data using the first information held in the first register, and subsequently causes the first cryptographic operation unit to perform the cryptographic operation on the second input data using the second information held in the second register.

According to this structure, the confidential information processing device according to the present invention can perform two cryptographic operations on one set of data. Furthermore, the first cryptographic operation unit performs the two cryptographic operations using information held in the first register and the second register. This makes it possible to reduce the number of times the information saving and restoring is performed between the storage unit and the first register or the second register. Hence the confidential information processing device according to the present invention can perform two cryptographic operations on one set of data at high speed.

Moreover, the confidential information processing device may further include: a first analysis circuit that extracts the first input data from a first stream, and incorporates first output data into the first stream, the first output data being a result of the cryptographic operation performed on the first input data by the first cryptographic operation unit; and a second analysis circuit that extracts the second input data from the first stream in which the first output data has been incorporated by the first analysis circuit, and incorporates second output data into the first stream, the second output data being a result of the cryptographic operation performed on the second input data by the first cryptographic operation unit.

According to this structure, the confidential information processing device according to the present invention can perform two cryptographic operations on data of different areas in a stream. Therefore, the confidential information processing device according to the present invention can easily support a plurality of cryptographic operations of various cryptographic schemes on one set of data.

Moreover, the first arbitration circuit may, when simultaneously receiving the cryptographic operation request made to the first cryptographic operation circuit and the cryptographic operation request made to the first pseudo-cryptographic operation circuit, cause the first cryptographic operation unit to perform the cryptographic operation on the second input data using the second information held in the second register.

According to this structure, the second cryptographic operation is prioritized over the first cryptographic operation. As a result, data for which the second cryptographic operation has been completed is outputted sequentially, with it being possible to reduce the stored amount of data before the second cryptographic operation (i.e., the stored amount of data for which the first cryptographic operation has been completed).

Moreover, the confidential information processing device may further perform a cryptographic operation of a different algorithm on third input data, wherein the confidential information processing device further includes a second cryptographic operation circuit, the second cryptographic operation circuit includes: a third register that holds third information necessary for performing the cryptographic operation on the third input data; and a second cryptographic operation unit that performs the cryptographic operation of the different algorithm from the cryptographic operation performed by the first cryptographic operation unit, the confidential information processing device further includes a second arbitration circuit that arbitrates cryptographic operation requests made to the first cryptographic operation circuit, the first pseudo-cryptographic operation circuit, and the second cryptographic operation circuit, and sends the cryptographic operation requests made to the first cryptographic operation circuit and the first pseudo-cryptographic operation circuit, to the first arbitration circuit, and the first arbitration circuit: causes the first cryptographic operation unit to perform the cryptographic operation on the first input data using the first information held in the first register, when the cryptographic operation request for the first input data made to the first cryptographic operation circuit is sent from the second arbitration circuit; and causes the first cryptographic operation unit to perform the cryptographic operation on the second input data using the second information held in the second register, when the cryptographic operation request for the second input data made to the first pseudo-cryptographic operation circuit is sent from the second arbitration circuit.

According to this structure, the confidential information processing device according to the present invention can perform cryptographic operations according to different cryptographic algorithms. In addition, by adding the second arbitration circuit to such a confidential information processing device that supports the different cryptographic algorithms, the first pseudo-cryptographic operation circuit can be treated and controlled same as the normal cryptographic operation circuits (the first cryptographic operation circuit and the second cryptographic operation circuit). Thus, the present invention can reduce the number of times the information saving and restoring is performed, without making a substantial change to a control system in a confidential information processing device that supports different cryptographic algorithms.

Moreover, the confidential information processing device may further perform the cryptographic operation of the different algorithm on fourth input data, wherein the confidential information processing device further includes: a second pseudo-cryptographic operation circuit; and a third arbitration circuit that arbitrates cryptographic operation requests made to the second cryptographic operation circuit and the second pseudo-cryptographic operation circuit, the second pseudo-cryptographic operation circuit includes a fourth register that holds fourth information necessary for performing the cryptographic operation on the fourth input data, and the third arbitration circuit: causes the second cryptographic operation unit to perform the cryptographic operation on the third input data using the third information held in the third register, when a cryptographic operation request for the third input data is made to the second cryptographic operation circuit; and causes the second cryptographic operation unit to perform the cryptographic operation on the fourth input data using the fourth information held in the fourth register, when a cryptographic operation request for the fourth input data is made to the second pseudo-cryptographic operation circuit.

According to this structure, the number of times the saving and restoring of information used for a cryptographic operation is performed can be reduced for each of a plurality of cryptographic algorithms. This enables the confidential information processing device according to the present invention to perform cryptographic operations at high speed.

Moreover, the cryptographic operation may be a cryptographic operation of a secret key cryptographic algorithm.

According to this structure, the confidential information processing device according to the present invention can perform a cryptographic operation of the secret key cryptographic algorithm on a plurality of sets of data and also perform a plurality of cryptographic operations of the secret key cryptographic algorithm on one set of data, without an increase in circuit area. Furthermore, the number of times the saving and restoring of information used for a cryptographic operation of the secret key cryptographic algorithm is performed can be reduced. Hence the confidential information processing device according to the present invention can perform cryptographic operations at high speed.

Moreover, the confidential information processing apparatus according to the present invention is a confidential information processing apparatus including: a reception unit that receives first input data and second input data from an external apparatus; and a confidential information processing device that performs a cryptographic operation on the first input data and the second input data, wherein the confidential information processing device includes: a first cryptographic operation circuit; a first pseudo-cryptographic operation circuit; and a first arbitration circuit that arbitrates cryptographic operation requests made to the first cryptographic operation circuit and the first pseudo-cryptographic operation circuit, the first cryptographic operation circuit includes: a first register that holds first information necessary for performing the cryptographic operation on the first input data; and a first cryptographic operation unit that performs the cryptographic operation, the first pseudo-cryptographic operation circuit includes a second register that holds second information necessary for performing the cryptographic operation on the second input data, the confidential information processing device further includes: a storage unit that holds the first information and the second information; and a control circuit that writes the first information and the second information held in the storage unit respectively into the first register and the second register, and saves the first information and the second information respectively held in the first register and the second register into the storage unit, the first arbitration circuit: causes the first cryptographic operation unit to perform the cryptographic operation on the first input data using the first information held in the first register, when a cryptographic operation request for the first input data is made to the first cryptographic operation circuit; and causes the first cryptographic operation unit to perform the cryptographic operation on the second input data using the second information held in the second register, when a cryptographic operation request for the second input data is made to the first pseudo-cryptographic operation circuit, and the confidential information processing apparatus further includes a display unit that displays first output data and second output data, the first output data being a result of the cryptographic operation performed on the first input data by the first cryptographic operation unit, and the second output data being a result of the cryptographic operation performed on the second input data by the first cryptographic operation unit.

According to this structure, in the confidential information processing apparatus that receives ciphertext data and reproduces and displays the data, a cryptographic operation can be performed on a plurality of sets of data and also a plurality of cryptographic operations can be performed on one set of data, without an increase in circuit area. In addition, the confidential information processing apparatus according to the present invention can perform cryptographic operations at high speed, by reducing the number of times the saving and restoring of information used for a cryptographic operation is performed.

Moreover, the confidential information processing apparatus according to the present invention is a confidential information processing apparatus including a confidential information processing device that performs a cryptographic operation on first input data and second input data, wherein the confidential information processing device includes: a first cryptographic operation circuit; a first pseudo-cryptographic operation circuit; and a first arbitration circuit that arbitrates cryptographic operation requests made to the first cryptographic operation circuit and the first pseudo-cryptographic operation circuit, the first cryptographic operation circuit includes: a first register that holds first information necessary for performing the cryptographic operation on the first input data; and a first cryptographic operation unit that performs the cryptographic operation, the first pseudo-cryptographic operation circuit includes a second register that holds second information necessary for performing the cryptographic operation on the second input data, the confidential information processing device further includes: a storage unit that holds the first information and the second information; and a control circuit that writes the first information and the second information held in the storage unit respectively into the first register and the second register, and saves the first information and the second information respectively held in the first register and the second register into the storage unit, the first arbitration circuit: causes the first cryptographic operation unit to perform the cryptographic operation on the first input data using the first information held in the first register, when a cryptographic operation request for the first input data is made to the first cryptographic operation circuit; and causes the first cryptographic operation unit to perform the cryptographic operation on the second input data using the second information held in the second register, when a cryptographic operation request for the second input data is made to the first pseudo-cryptographic operation circuit, and the confidential information processing apparatus further includes a transmission unit that transmits first output data and second output data to an external apparatus, the first output data being a result of the cryptographic operation performed on the first input data by the first cryptographic operation unit, and the second output data being a result of the cryptographic operation performed on the second input data by the first cryptographic operation unit.

According to this structure, in the confidential information processing apparatus that encrypts plaintext data and transmits the data to an external apparatus, a cryptographic operation can be performed on a plurality of sets of data and also a plurality of cryptographic operations can be performed on one set of data, without an increase in circuit area. In addition, the confidential information processing apparatus according to the present invention can perform cryptographic operations at high speed, by reducing the number of times the saving and restoring of information used for a cryptographic operation is performed.

Moreover, the confidential information processing method according to the present invention is a confidential information processing method in a confidential information processing device that performs a cryptographic operation on first input data and second input data, wherein the confidential information processing device includes: a first cryptographic operation circuit; a first pseudo-cryptographic operation circuit; and a first arbitration circuit that arbitrates cryptographic operation requests made to the first cryptographic operation circuit and the first pseudo-cryptographic operation circuit, the first cryptographic operation circuit includes: a first register that holds first information necessary for performing the cryptographic operation on the first input data; and a first cryptographic operation unit that performs the cryptographic operation, the first pseudo-cryptographic operation circuit includes a second register that holds second information necessary for performing the cryptographic operation on the second input data, the confidential information processing device further includes: a storage unit that holds the first information and the second information; and a control circuit that writes the first information and the second information held in the storage unit respectively into the first register and the second register, and saves the first information and the second information respectively held in the first register and the second register into the storage unit, and the confidential information processing method includes: causing, by the first arbitration circuit, the first cryptographic operation unit to perform the cryptographic operation on the first input data using the first information held in the first register, when a cryptographic operation request for the first input data is made to the first cryptographic operation circuit; and causing, by the first arbitration circuit, the first cryptographic operation unit to perform the cryptographic operation on the second input data using the second information held in the second register, when a cryptographic operation request for the second input data is made to the first pseudo-cryptographic operation circuit.

According to this method, the first cryptographic operation unit performs a cryptographic operation using information held in the first register or the second register. Accordingly, in the case of switching the cryptographic operation between the first input data and the second input data, the information saving and restoring between the storage unit and the first register or the second register does not need to be performed each time the data which is subject to the cryptographic operation is switched. As a result, the number of times the information saving and restoring is performed can be reduced. Hence cryptographic operations can be performed at high speed by the confidential information processing method according to the present invention.

As described above, according to the present invention, it is possible to provide a confidential information processing device, a confidential information processing apparatus, and a confidential information processing method that can perform a cryptographic operation on a plurality of sets of data and also perform a plurality of cryptographic operations on one set of data, without an increase in circuit area.

### FURTHER INFORMATION ABOUT TECHNICAL BACKGROUND TO THIS APPLICATION

The disclosure of Japanese Patent Application No. 2007-210235 filed on Aug. 10, 2007 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 shows a structure of a conventional confidential information processing device;

FIG. 2 shows an appearance of a confidential information processing apparatus according to an embodiment of the present invention;

FIG. 3 is a block diagram showing a structure of the confidential information processing apparatus according to the embodiment of the present invention;

FIG. 4 is a block diagram showing a structure of a confidential information processing device according to the embodiment of the present invention;

FIG. 5 shows a structure of a context correspondence table according to the embodiment of the present invention;

FIG. 6 shows a structure of a cryptographic algorithm correspondence table according to the embodiment of the present invention;

FIG. 7 is a block diagram showing structures of a pseudo-cryptographic operation circuit and a cryptographic operation circuit corresponding to the pseudo-cryptographic operation circuit, according to the embodiment of the present invention;

FIG. 8 is a block diagram showing a structure of a cryptographic operation circuit according to the embodiment of the present invention;

FIG. 9 is a flowchart showing a flow of processing of the confidential information processing device according to the embodiment of the present invention;

FIG. 10 shows a flow of data in the processing of the confidential information processing device according to the embodiment of the present invention;

FIG. 11 is a flowchart showing a flow of processing of an arbitration circuit according to the embodiment of the present invention;

FIG. 12 is a flowchart showing a flow of processing of the cryptographic operation circuit according to the embodiment of the present invention;

FIG. 13 is a flowchart showing a flow of processing of the pseudo-cryptographic operation circuit according to the embodiment of the present invention;

FIG. 14 shows an operation state of the cryptographic operation circuit according to the embodiment of the present invention;

FIG. 15 shows an operation state of a conventional cryptographic operation circuit; and

FIG. 16 is a block diagram showing a structure of a variation of the confidential information processing apparatus according to the embodiment of the present invention.

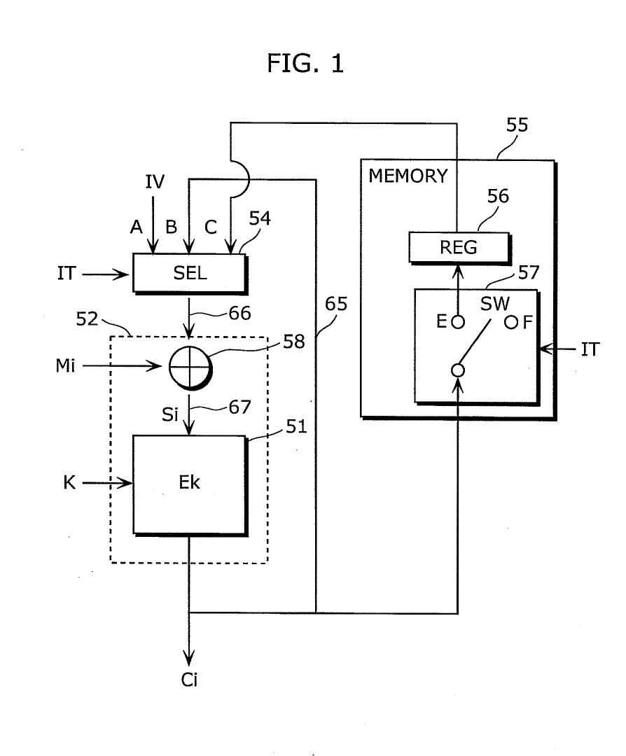

### DESCRIPTION OF THE PREFERRED EMBODIMENT

The following describes an embodiment of a confidential information processing device according to the present invention in detail, with reference to drawings.

A structure of a confidential information processing apparatus that includes the confidential information processing device according to the embodiment of the present invention is described first.

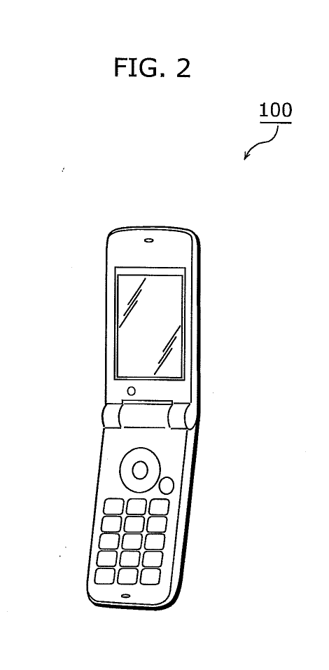

FIG. 2 shows an example of an appearance of the confidential information processing apparatus that includes the confidential information processing device according to the embodiment of the present invention. As shown in FIG. 2, a confidential information processing apparatus 100 is a mobile phone as one example.

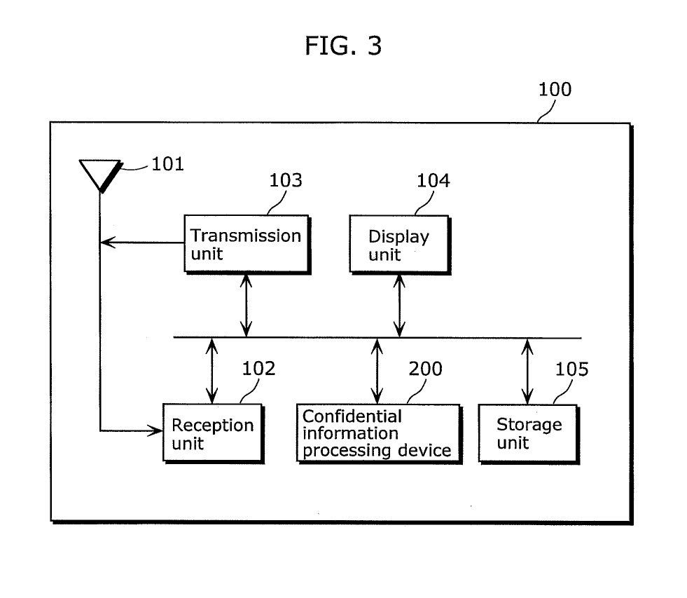

FIG. 3 is a block diagram showing a structure of the confidential information processing apparatus 100. The confidential information processing apparatus 100 shown in FIG. 3 includes an antenna 101, a reception unit 102, a transmission unit 103, a display unit 104, a storage unit 105, and a confidential information processing device 200.

The antenna 101 is an antenna used for transmission and reception.

The reception unit 102 receives a stream, such as a moving picture stream or an audio stream, which is transmitted from an external apparatus, via the antenna 101.

The storage unit 105 stores a stream received by the reception unit 102. The storage unit 105 also stores moving picture data and the like generated by the confidential information processing apparatus 100. As one example, the storage unit 105 stores moving picture data taken by a camera (not illustrated) equipped in the confidential information processing apparatus 100. For instance, the storage unit 105 is a Random Access Memory (RAM), a hard disk, a nonvolatile memory, or the like.

The confidential information processing device 200 is the confidential information processing device according to the embodiment of the present invention. The confidential information processing device 200 decrypts ciphertext data included in a stream received by the reception unit 102. The confidential information processing device 200 also encrypts plaintext data included in a stream received by the reception unit 102, moving picture data held in the storage unit 105, and the like.

The transmission unit 103 transmits a stream encrypted by the confidential information processing device 200, to an external apparatus via the antenna 101.

The display unit 104 displays a stream decrypted by the confidential information processing device 200.

Note that the confidential information processing device 200 may perform a cryptographic operation on data stored on a recording medium (such as a Secure Digital (SD) memory). The confidential information processing device 200 may also perform a cryptographic operation on data transmitted to or received from an external apparatus connected via a network.

Moreover, the functions of the reception unit 102 and the transmission unit 103 may be realized by a dedicated circuit, or by a CPU or the like executing a program.

A structure of the confidential information processing device 200 is described next.

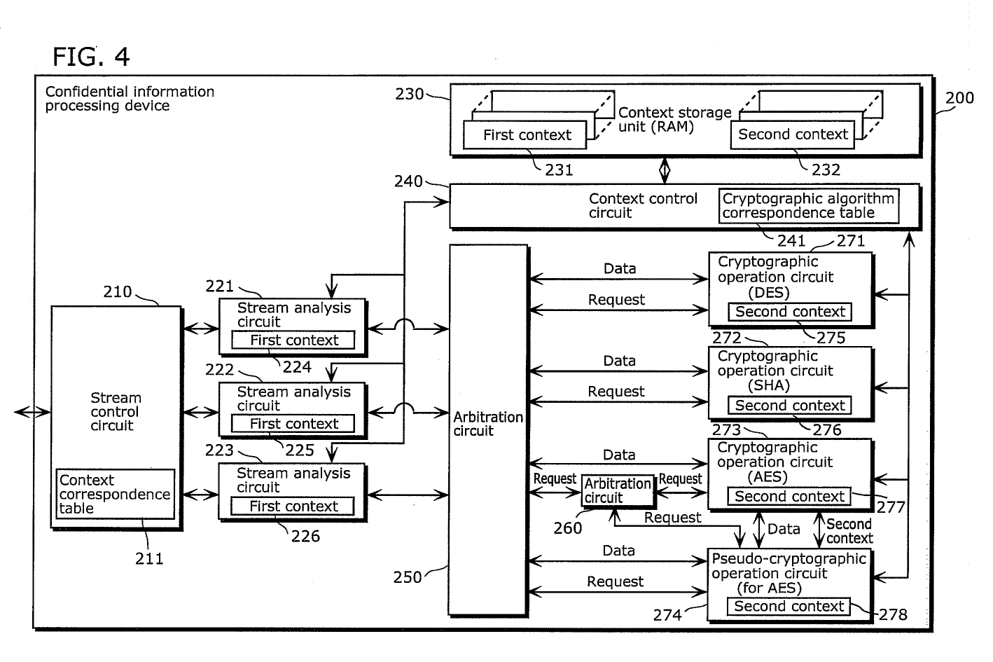

FIG. 4 is a block diagram showing the structure of the confidential information processing device 200 according to the embodiment of the present invention.

The confidential information processing device 200 can perform a cryptographic operation on a plurality of streams which are inputted in a congestion state. The confidential information processing device 200 can also perform a plurality of cryptographic operations on one stream. The confidential information processing device 200 includes a stream control circuit 210, three stream analysis circuits 221, 222, and 223, a context storage unit 230, a context control circuit 240, an arbitration circuit 250, an arbitration circuit 260, three cryptographic operation circuits 271, 272, and 273, and a pseudo-cryptographic operation circuit 274.

The stream control circuit 210 stores a context correspondence table 211. The context correspondence table 211 is a table showing a correspondence between an input stream and the number of cryptographic operations to be performed for the input stream as well as a type of context (context ID) used in each cryptographic operation. The stream control circuit 210 outputs a stream received by the reception unit 102 to any of the stream analysis circuits 221, 222, and 223, according to the context correspondence table 211.

The stream control circuit 210 also outputs a stream outputted from any of the stream analysis circuits 221, 222, and 223, to an external device such as the transmission unit 103 or another one of the stream analysis circuits 221, 222, and 223, according to the context correspondence table 211.

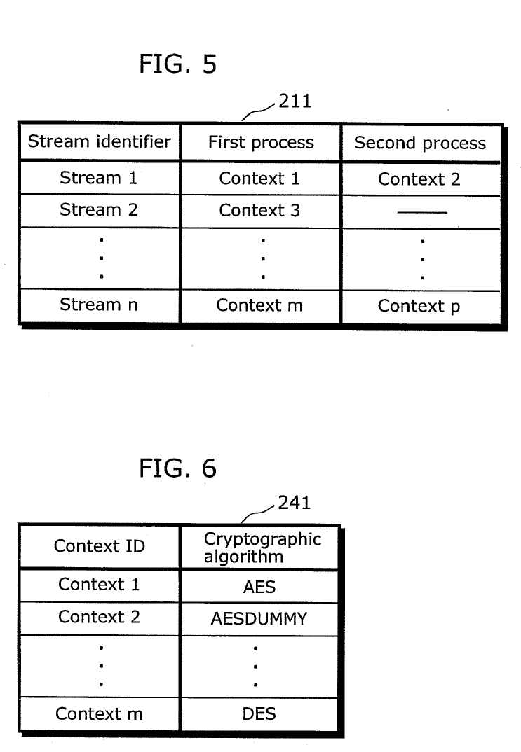

FIG. 5 shows an example of a structure of the context correspondence table 211. As shown in FIG. 5, the context correspondence table 211 specifies, for each stream identifier, a context ID (context identifier) of a cryptographic operation to be executed. In detail, a context ID of a first cryptographic operation (a cryptographic operation performed first) and a context ID of a second cryptographic operation (a cryptographic operation performed second) are shown for each stream identifier in the context correspondence table 211. When a context ID of the “second process” is designated for a stream in the context correspondence table 211, two consecutive cryptographic operations are performed on that stream. In the example shown in FIG. 5, a cryptographic operation of a context ID “context 1” is performed on a stream of a stream identifier “stream 1”, and then a cryptographic operation of a context ID “context 2” is performed on the same stream. On the other hand, only a cryptographic operation of a context ID “context 3” is performed on a stream of a stream ID “stream 2”, and no second cryptographic operation is performed.

The stream analysis circuits 221, 222, and 223 respectively hold first contexts 224, 225, and 226. Each of the first contexts 224, 225, and 226 is information necessary for a stream analysis, such as a format type, a header length, a frame length, and a footer length. Each of the first contexts 224, 225, and 226 also includes its own context ID.

Each of the stream analysis circuits 221, 222, and 223 analyzes an input stream, using the first context 224, 225, or 226 held therein. In detail, each of the stream analysis circuits 221, 222, and 223 extracts data (hereafter referred to as “input data”) that is subject to a cryptographic operation (encryption or decryption) from data included in the input stream, using the first context 224, 225, or 226 held therein. Each of the stream analysis circuits 221, 222, and 223 outputs the extracted input data and an input request which is a request for a cryptographic operation, to the arbitration circuit 250.

Each of the stream analysis circuits 221, 222, and 223 also performs saving and restoring of the first context 224, 225, or 226 held therein, depending on whether or not a designated context ID matches a currently held context ID. In detail, when the designated context ID matches the currently held context ID, each of the stream analysis circuits 221, 222, and 223 analyzes the input stream using the first context 224, 225, or 226 held therein. When the designated context ID does not match the currently held context ID, each of the stream analysis circuits 221, 222, and 223 makes a context save and restore request to the context control circuit 240. Upon receiving the request from any of the stream analysis circuits 221, 222, and 223, the context control circuit 240 saves the first context 224, 225, or 226 currently held in the stream analysis circuit making the request into the context storage unit 230, and sets a first context 231 of the designated context ID held in the context storage unit 230 into the stream analysis circuit. The stream analysis circuit extracts data that is subject to a cryptographic operation (encryption or decryption) from the input stream, using the newly set first context.

Furthermore, each of the stream analysis circuits 221, 222, and 223 incorporates, in the original stream, data (hereafter referred to as “output data”) generated as a result of a cryptographic operation by the cryptographic operation circuit 271, 272, or 273, and outputs the resulting stream to the stream control circuit 210.

The context storage unit 230 stores a plurality of first contexts 231 and a plurality of second contexts 232. Each of the plurality of first contexts 231 is information necessary for a stream analysis by the stream analysis circuit 221, 222, or 223, such as a format type, a header length, a frame length, and a footer length. Each of the plurality of second contexts 232 is information necessary for a cryptographic operation. In more detail, each of the plurality of second contexts 232 is information that includes at least one of a key, an intermediate value, an initial value, and a chain value in a cryptographic operation. Each of the plurality of first contexts 231 and the plurality of second contexts 232 also includes its own context ID.

The context storage unit 230 is realized by a RAM as one example. Note here that the context storage unit 230 may store a corresponding pair of first context 231 and second context 232 as one context which is associated with one context ID.

The context control circuit 240 saves, in response to a context save request from any of the stream analysis circuits 221, 222, and 223, the first context 224, 225, or 226 held in the stream analysis circuit making the request into the context storage unit 230. The context control circuit 240 also restores, in response to a context restore request from any of the stream analysis circuits 221, 222, and 223, a first context 231 held in the context storage unit 230 into the stream analysis circuit making the request.

In addition, the context control circuit 240 saves, in response to a context save request from any of the cryptographic operation circuits 271, 272, and 273 and the pseudo-cryptographic operation circuit 274, a second context 275, 276, 277, or 278 held in the cryptographic operation circuit 271, 272, or 273 or the pseudo-cryptographic operation circuit 274 making the request, by writing the second context 275, 276, 277, or 278 into the context storage unit 230. The context control circuit 240 also restores, in response to a context restore request from any of the cryptographic operation circuits 271, 272, and 273 and the pseudo-cryptographic operation circuit 274, a second context 232 held in the context storage unit 230, by writing the second context 232 into the cryptographic operation circuit 271, 272, or 273 or the pseudo-cryptographic operation circuit 274 making the request.

Furthermore, the context control circuit 240 stores a cryptographic algorithm correspondence table 241. The cryptographic algorithm correspondence table 241 is a table showing a correspondence between a context ID used in a cryptographic operation and a cryptographic algorithm.

FIG. 6 shows an example of a structure of the cryptographic algorithm correspondence table 241. As shown in FIG. 6, the cryptographic algorithm correspondence table 241 shows a cryptographic algorithm corresponding to each context ID.

Note that the context correspondence table 211, the cryptographic algorithm correspondence table 241, each first context 231, and a key and an initial value included in each second context 232 are determined by a CPU (not illustrated) or the like included in the confidential information processing device 200 or the confidential information processing apparatus 100, before initiating a cryptographic operation.

The cryptographic operation circuits 271, 272, and 273 each perform a cryptographic operation according to a different cryptographic algorithm. In this embodiment, the cryptographic operation circuit 271 performs a cryptographic operation according to Data Encryption Standard (DES), the cryptographic operation circuit 272 performs a cryptographic operation according to Secure Hash Algorithm (SHA), and the cryptographic operation circuit 273 performs a cryptographic operation according to Advanced Encryption Standard (AES). DES and AES are secret key cryptographic algorithms, whereas SHA is a cryptographic algorithm including a hash operation.

The cryptographic operation circuits 271, 272, and 273 also hold the second contexts 275, 276, and 277, respectively.

The pseudo-cryptographic operation circuit 274 is a dummy cryptographic operation circuit, which does not perform an actual cryptographic operation. The pseudo-cryptographic operation circuit 274 corresponds to the cryptographic operation circuit 273. The pseudo-cryptographic operation circuit 274 also holds the second context 278.

When performing two consecutive cryptographic operations according to AES, a cryptographic algorithm used in the second process is “AES-DUMMY” in the cryptographic algorithm correspondence table 241 shown in FIG. 6. AES-DUMMY is treated as a cryptographic algorithm performed by the pseudo-cryptographic operation circuit 274. Therefore, when performing two consecutive cryptographic operations according to AES on one stream, the cryptographic algorithm AES is designated for a context of the first process, and the cryptographic algorithm AES-DUMMY is designated for a context of the second process. By doing so, a cryptographic operation using the pseudo-cryptographic operation circuit 274 can be realized.

The arbitration circuit 250 arbitrates input requests outputted from the stream analysis circuits 221, 222, and 223. In detail, when at least two of the stream analysis circuits 221, 222, and 223 simultaneously output input requests for a same cryptographic algorithm, the arbitration circuit 250 determines which of the input requests from the at least two of the stream analysis circuits 221, 222, and 223 is to be processed. For example, the arbitration circuit 250 determines the input request to be processed, in accordance with priorities assigned to the stream analysis circuits 221, 222, and 223. As an alternative, the arbitration circuit 250 may determine the input request to be processed, using other algorithms such as a round robin method. The same cryptographic algorithm mentioned here is a cryptographic algorithm specified in the cryptographic algorithm correspondence table 241. For example, AES and AES-DUMMY are recognized as separate algorithms in this embodiment.

When receiving an input request from any of the stream analysis circuits 221, 222, and 223, the arbitration circuit 250 determines a cryptographic algorithm to be executed, in accordance with the cryptographic algorithm correspondence table 241. The arbitration circuit 250 outputs input data accompanying the input request to the cryptographic operation circuit 271, 272, or 273 or the pseudo-cryptographic operation circuit 274 corresponding to the determined cryptographic algorithm, and also outputs the input request to the cryptographic operation circuit 271 or 272, the pseudo-cryptographic operation circuit 274, or the arbitration circuit 260.

In more detail, when receiving an input request for a cryptographic operation according to DES, the arbitration circuit 250 outputs input data accompanying the input request and the input request to the cryptographic operation circuit 271. When receiving an input request for a cryptographic operation according to SHA, the arbitration circuit 250 outputs input data accompanying the input request and the input request to the cryptographic operation circuit 272. When receiving an input request for a cryptographic operation according to AES, the arbitration circuit 250 outputs input data accompanying the input request to the cryptographic operation circuit 273, and the input request to the arbitration circuit 260. When receiving an input request for a cryptographic operation according to AES-DUMMY, the arbitration circuit 250 outputs input data accompanying the input request and the input request to the pseudo-cryptographic operation circuit 274. The input request outputted to the pseudo-cryptographic operation circuit 274 is then outputted to the arbitration circuit 260 from the pseudo-cryptographic operation circuit 274.

In addition, the arbitration circuit 250 outputs output data received from any of the cryptographic operation circuits 271, 272, and 273 and the pseudo-cryptographic operation circuit 274, to the stream analysis circuit 221, 222, or 223 making the input request.

The arbitration circuit 260 arbitrates an input request made to the cryptographic operation circuit 273 received from the arbitration circuit 250, and an input request made to the pseudo-cryptographic operation circuit 274 received from the pseudo-cryptographic operation circuit 274. That is, the arbitration circuit 260 arbitrates cryptographic operation requests made to the cryptographic operation circuit 273 and the pseudo-cryptographic operation circuit 274. In more detail, when receiving an input request made to the cryptographic operation circuit 273, the arbitration circuit 260 outputs the input request to the cryptographic operation circuit 273, thereby causing the cryptographic operation circuit 273 to perform a cryptographic operation using the second context 277. When receiving an input request made to the pseudo-cryptographic operation circuit 274, the arbitration circuit 260 outputs the input request to the cryptographic operation circuit 273, thereby causing the cryptographic operation circuit 273 to perform a cryptographic operation using the second context 278.

When simultaneously receiving the input request made to the cryptographic operation circuit 273 and the input request made to the pseudo-cryptographic operation circuit 274, the arbitration circuit 260 prioritizes the input request made to the pseudo-cryptographic operation circuit 274. Which is to say, when simultaneously receiving the input request made to the cryptographic operation circuit 273 and the input request made to the pseudo-cryptographic operation circuit 274, the arbitration circuit 260 outputs the input request made to the pseudo-cryptographic operation circuit 274 to the cryptographic operation circuit 273, thereby causing the cryptographic operation circuit 273 to perform a cryptographic operation using the second context 278.

The following describes detailed structures of the cryptographic operation circuits 271, 272, and 273 and the pseudo-cryptographic operation circuit 274.

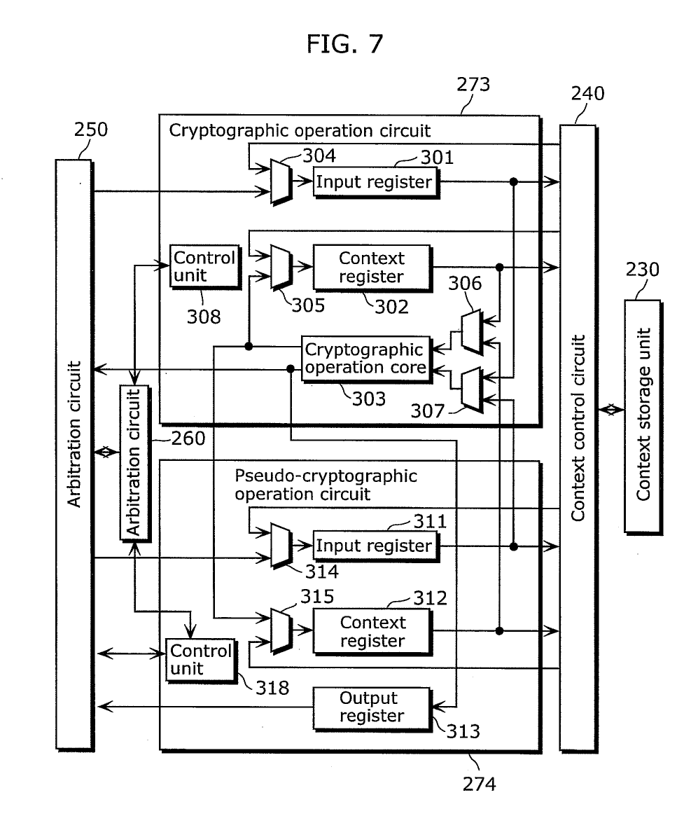

FIG. 7 is a block diagram showing detailed structures of the cryptographic operation circuit 273 and the pseudo-cryptographic operation circuit 274.

The cryptographic operation circuit 273 includes an input register 301, a context register 302, a cryptographic operation core 303, selectors 304, 305, 306, and 307, and a control unit 308.

The selector 304 selects one of input data outputted from the arbitration circuit 250 and input data outputted from the context control circuit 240.

The input register 301 holds the input data selected by the selector 304.

The selector 305 selects one of a second context outputted from the cryptographic operation core 303 and a second context outputted from the context control circuit 240.

The context register 302 holds the second context 277 selected by the selector 305. This second context 277 is information necessary for a cryptographic operation, which includes at least one of a key, an intermediate value, an initial value, and a chain value in the cryptographic operation.

The selector 306 selects one of the second context 277 held in the context register 302 and the second context 278 held in a context register 312 in the pseudo-cryptographic operation circuit 274.

The selector 307 selects one of the input data held in the input register 301 and input data held in an input register 311 in the pseudo-cryptographic operation circuit 274.

The cryptographic operation core 303 performs a cryptographic operation on the input data selected by the selector 307, using the second context selected by the selector 306. In this embodiment, the cryptographic operation core 303 performs a cryptographic operation according to AES. The cryptographic operation core 303 outputs output data generated as a result of the cryptographic operation, and a second context. The second context outputted by the cryptographic operation core 303 includes an intermediate value, a chain value, and the like generated by the cryptographic operation.

The control unit 308 controls the selectors 304, 305, 306, and 307, based on an input request from the arbitration circuit 260 and whether or not to perform second context saving and restoring. In detail, when the input request from the arbitration circuit 260 is an input request made to the cryptographic operation circuit 273, the control unit 308 causes the selector 306 to select the second context 277 held in the context register 302, and the selector 307 to select the input data held in the input register 301. When the input request from the arbitration circuit 260 is an input request made to the pseudo-cryptographic operation circuit 274, the control unit 308 causes the selector 306 to select the second context 278 held in the context register 312, and the selector 307 to select the input data held in the input register 311.

Moreover, when performing second context restoring, the control unit 308 causes the selector 305 to select the second context outputted from the context control circuit 240. When not performing second context restoring, the control unit 308 causes the selector 304 to select the input data outputted from the arbitration circuit 250, and the selector 305 to select the second context outputted from the cryptographic operation core 303. Furthermore, when suspending the cryptographic operation and performing saving, the context control circuit 240 saves the input data held in the input register 301, into the context storage unit 230. When restoring the input data, the control unit 308 causes the selector 304 to select the input data outputted from the context control circuit 240.

After the cryptographic operation by the cryptographic operation core 303 ends, the control unit 308 outputs an output request which is a request to output the output data to the stream control circuit 210, to the arbitration circuit 260.

The pseudo-cryptographic operation circuit 274 includes the input register 311, the context register 312, an output register 313, selectors 314 and 315, and a control unit 318.

The selector 314 selects one of input data outputted from the arbitration circuit 250 and input data outputted from the context control circuit 240.

The input register 311 holds the input data selected by the selector 314.

The selector 315 selects one of a second context outputted from the cryptographic operation core 303 and a second context outputted from the context control circuit 240.

The context register 312 holds the second context 278 selected by the selector 315. This second context 278 is information necessary for a cryptographic operation, which includes at least one of a key, an intermediate value, an initial value, and a chain value in the cryptographic operation.

The output register 313 holds output data generated as a result of the cryptographic operation by the cryptographic operation core 303. The output register 313 also outputs the held output data to the arbitration circuit 250.

The control unit 318 outputs, upon receiving an input request from the arbitration circuit 250, the input request to the arbitration circuit 260.

The control unit 318 also controls the selectors 314 and 315, based on whether or not to perform second context restoring. When performing second context restoring, the control unit 318 causes the selector 315 to select the second context outputted from the context control circuit 240. When not performing second context restoring, the control unit 318 causes the selector 314 to select the input data outputted from the arbitration circuit 250, and the selector 315 to select the second context outputted from the cryptographic operation core 303. Moreover, when suspending the cryptographic operation and performing saving, the context control circuit 240 saves the input data held in the input register 311, into the context storage unit 230. When restoring the input data, the control unit 318 causes the selector 314 to select the input data outputted from the context control circuit 240.

After the output data generated as a result of the cryptographic operation by the cryptographic operation core 303 is obtained in the output register 313, the control unit 318 outputs an output request to the arbitration circuit 250.

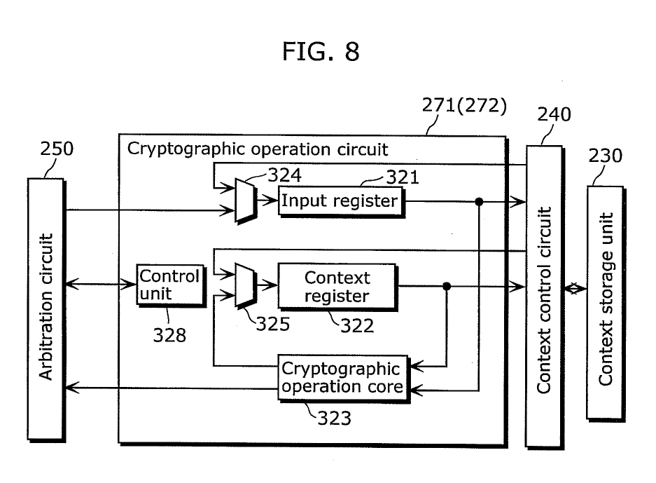

FIG. 8 is a block diagram showing a detailed structure of the cryptographic operation circuit 271.

The cryptographic operation circuit 271 includes an input register 321, a context register 322, a cryptographic operation core 323, selectors 324 and 325, and a control unit 328.

The selector 324 selects one of input data outputted from the arbitration circuit 250 and input data outputted from the context control circuit 240.

The input register 321 holds the input data selected by the selector 324.

The selector 325 selects one of a second context outputted from the cryptographic operation core 323 and a second context outputted from the context control circuit 240.

The context register 322 holds the second context 275 selected by the selector 325.

The cryptographic operation core 323 performs a cryptographic operation on the input data held in the input register 321, using the second context 275 held in the context register 322. In this embodiment, the cryptographic operation core 323 performs a cryptographic operation according to DES. The cryptographic operation core 323 outputs output data generated as a result of the cryptographic operation, and a second context. The second context outputted by the cryptographic operation core 323 includes an intermediate value, a chain value, and the like generated by the cryptographic operation.

The control unit 328 controls the selectors 324 and 325, based on whether or not to perform second context restoring. When performing second context restoring, the control unit 328 causes the selector 325 to select the second context outputted from the context control circuit 240. When not performing second context restoring, the control unit 328 causes the selector 324 to select the input data outputted from the arbitration circuit 250, and the selector 325 to select the second context outputted from the cryptographic operation core 323. Moreover, when suspending the cryptographic operation and performing saving, the context control circuit 240 saves the input data held in the input register 321, into the context storage unit 230. When restoring the input data, the control unit 328 causes the selector 324 to select the input data outputted from the context control circuit 240.

After the cryptographic operation by the cryptographic operation core 323 ends, the control unit 328 outputs an output request to the arbitration circuit 250.

Note that the cryptographic operation circuit 272 has the same structure as the cryptographic operation circuit 271, except that the cryptographic operation core 323 performs a cryptographic operation according to SHA.

The following describes an operational procedure of the confidential information processing device 200. As one example, an operational procedure of cryptographic operation performed by the confidential information processing device 200 on the stream of the stream identifier “stream 1” shown in FIG. 5 is described below. That is, an operational procedure of the confidential information processing device 200 in the case of performing two cryptographic operations according to AES on one stream is described below. For instance, this operational procedure corresponds to the case where a Message Authentication Code (MAC) process using AES is performed on an AES-encrypted stream, in Security Architecture for Internet Protocol (IPSec) and the like.

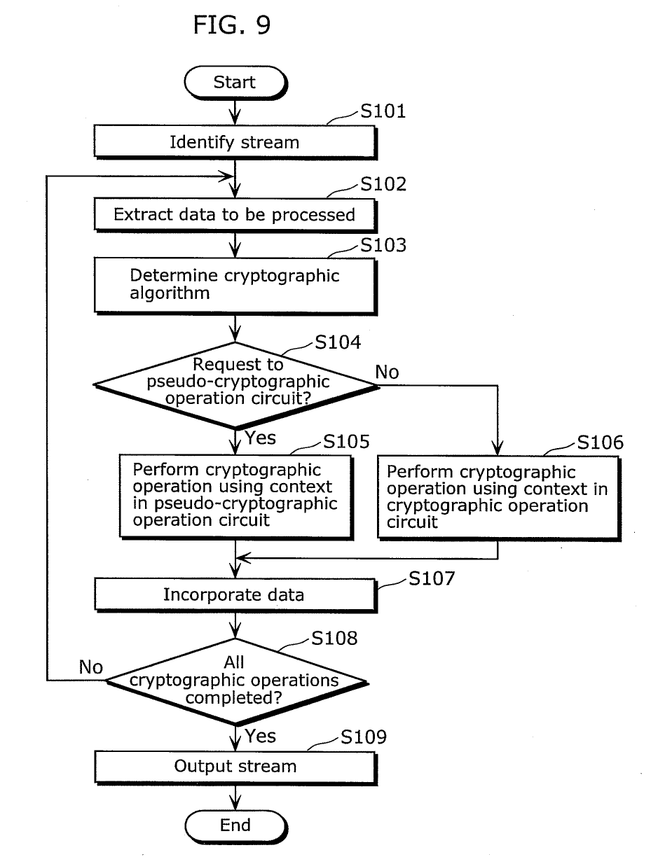

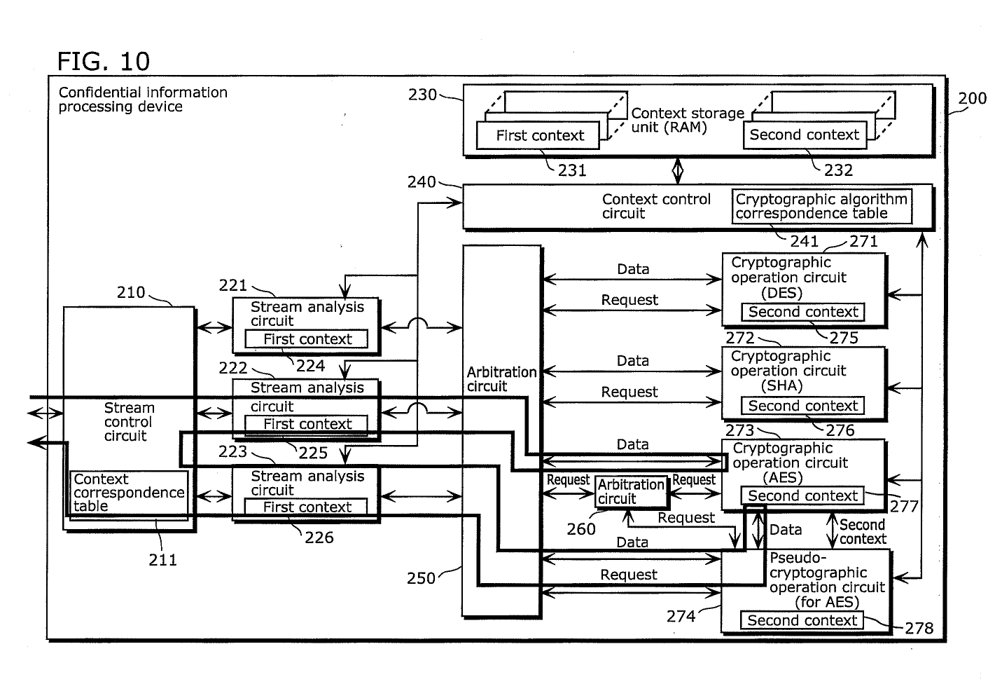

FIG. 9 is a flowchart showing a flow of cryptographic operation processing by the confidential information processing device 200. FIG. 10 shows a flow of data in the case where two cryptographic operations according to AES are performed on one stream.

As shown in FIG. 9, first the stream control circuit 210 identifies an input stream (hereafter referred to as “first stream”) (Step S101). In detail, the stream control circuit 210 references the context correspondence table 211, and determines the number of cryptographic operations corresponding to a stream identifier of the first stream and a context ID used in each of these cryptographic operations. Since the stream identifier of the first stream is “stream 1”, the stream control circuit 210 determines that a cryptographic operation of “context 1” is performed as the first process, and a cryptographic operation of “context 2” is performed as the second process. After this, the stream control circuit 210 outputs the first stream to, for example, the stream analysis circuit 222.

The stream analysis circuit 222 extracts data to be processed (hereafter referred to as “first input data”) from the first stream outputted from the stream control circuit 210, based on the first context 225 corresponding to “context 1” (Step S102). It is assumed here that the stream analysis circuit 222 holds the first context corresponding to “context 1”. In the case where the stream analysis circuit 222 does not hold the first context corresponding to “context 1”, the stream analysis circuit 222 performs first context saving and restoring, by making a first context save and restore request to the context control circuit 240. As a result, the first context corresponding to “context 1” is held in the stream analysis circuit 222.

The stream analysis circuit 222 outputs the extracted first input data and an input request to the arbitration circuit 250. Here, the input request includes information about the context corresponding to the cryptographic operation (information showing “context 1” such as a context ID).

The arbitration circuit 250 references the cryptographic algorithm correspondence table 241, and determines a cryptographic algorithm corresponding to the input request outputted from the stream analysis circuit 222 (Step S103). Here, the arbitration circuit 250 references the cryptographic algorithm correspondence table 241, and determines that the cryptographic algorithm corresponding to “context 1” is AES. The arbitration circuit 250 accordingly outputs an input request made to the cryptographic operation circuit 273 corresponding to the cryptographic algorithm AES, to the arbitration circuit 260. The arbitration circuit 250 also outputs the first input data extracted by the stream analysis circuit 222, to the cryptographic operation circuit 273.

Moreover, in the case where input requests for a same cryptographic algorithm are simultaneously inputted from at least two of the stream analysis circuits 221, 222, and 223, the arbitration circuit 250 determines which of the input requests from the at least two of the stream analysis circuits 221, 222, and 223 is to be processed.

The arbitration circuit 260 outputs the input request made to the cryptographic operation circuit 273, which is outputted from the arbitration circuit 250, to the cryptographic operation circuit 273.

Here, since the input request outputted from the arbitration circuit 260 is the input request made to the cryptographic operation circuit 273 (Step S104: No), the cryptographic operation circuit 273 performs a cryptographic operation on the first input data outputted from the arbitration circuit 250, using the second context 277 held in the context register 302 (Step S106). The cryptographic operation circuit 273 outputs data (hereafter referred to as “first output data”) generated as a result of the cryptographic operation, to the arbitration circuit 250. The cryptographic operation circuit 273 also outputs an output request to the arbitration circuit 260.

The arbitration circuit 260 outputs the output request outputted from the cryptographic operation circuit 273, to the arbitration circuit 250.

The arbitration circuit 250 outputs the first output data outputted from the cryptographic operation circuit 273, to the stream analysis circuit 222 which is the source of the input request, according to the output request from the arbitration circuit 260.

The stream analysis circuit 222 incorporates the first output data outputted from the arbitration circuit 250 into the original first stream, and outputs the resulting stream to the stream control circuit 210 (Step S107).

This completes the first cryptographic operation.

Since all cryptographic operations for the input stream have not been completed yet (Step S108: No), the stream control circuit 210 outputs the stream (hereafter referred to as “second stream”) for which the first cryptographic operation has been completed to, for example, the stream analysis circuit 223.

The stream analysis circuit 223 extracts data to be processed (hereafter referred to as “second input data”) from the second stream outputted from the stream control circuit 210, based on the first context 226 corresponding to “context 2” (Step S102). Here, the stream analysis circuit 223 performs the input data extraction, using the first context 226 different from the first context 225 used by the stream analysis circuit 222 in the first process. Which is to say, the stream analysis circuit 223 extracts the second input data of a different area from the first input data in the first stream. It is assumed here that the stream analysis circuit 223 holds the first context corresponding to “context 2”. The stream analysis circuit 223 outputs the extracted second input data and an input request to the arbitration circuit 250.

The arbitration circuit 250 references the cryptographic algorithm correspondence table 241, and determines a cryptographic algorithm corresponding to the input request outputted from the stream analysis circuit 223 (Step S103). For example, the arbitration circuit 250 determines that the cryptographic algorithm corresponding to “context 2” is AES-DUMMY. The arbitration circuit 250 outputs an input request made to the pseudo-cryptographic operation circuit 274 corresponding to the cryptographic algorithm AES-DUMMY, to the pseudo-cryptographic operation circuit 274. The arbitration circuit 250 also outputs the second input data extracted by the stream analysis circuit 223, to the pseudo-cryptographic operation circuit 274.

The pseudo-cryptographic operation circuit 274 outputs the input request outputted from the arbitration circuit 250, to the arbitration circuit 260.

The arbitration circuit 260 outputs the input request made to the pseudo-cryptographic operation circuit 274, which is outputted from the pseudo-cryptographic operation circuit 274, to the cryptographic operation circuit 273.

Here, since the input request outputted from the arbitration circuit 260 is the input request made to the pseudo-cryptographic operation circuit 274 (Step S104: Yes), the cryptographic operation circuit 273 performs a cryptographic operation on the second input data outputted from the pseudo-cryptographic operation circuit 274, using the second context 278 held in the context register 312 (Step S106). The cryptographic operation circuit 273 outputs data (hereafter referred to as “second output data”) generated as a result of the cryptographic operation, to the pseudo-cryptographic operation circuit 274. The cryptographic operation circuit 273 also outputs an output request to the arbitration circuit 260.

The arbitration circuit 260 outputs the output request from the cryptographic operation circuit 273, to the pseudo-cryptographic operation circuit 274.

The pseudo-cryptographic operation circuit 274 outputs the output request and the second output data outputted from the cryptographic operation circuit 273, to the arbitration circuit 250.

The arbitration circuit 250 outputs the second output data outputted from the pseudo-cryptographic operation circuit 274, to the stream analysis circuit 223 which is the source of the input request, according to the output request from the pseudo-cryptographic operation circuit 274.

The stream analysis circuit 223 incorporates the second output data outputted from the arbitration circuit 250 into the original second stream, and outputs the resulting stream to the stream control circuit 210 (Step S107).

This completes the second cryptographic operation.

Since all cryptographic operations for the input stream have been completed (Step S108: Yes), the stream control circuit 210 outputs the stream for which the second cryptographic operation has been completed, to outside (Step S109).

In this way, two cryptographic operations according to AES are performed on one stream.

The following individually describes detailed operational procedures of the arbitration circuit 260, the cryptographic operation circuit 273, and the pseudo-cryptographic operation circuit 274.

The detailed operational procedure of the arbitration circuit 260 in Steps S104, S105, and S106 shown in FIG. 9 is described first.

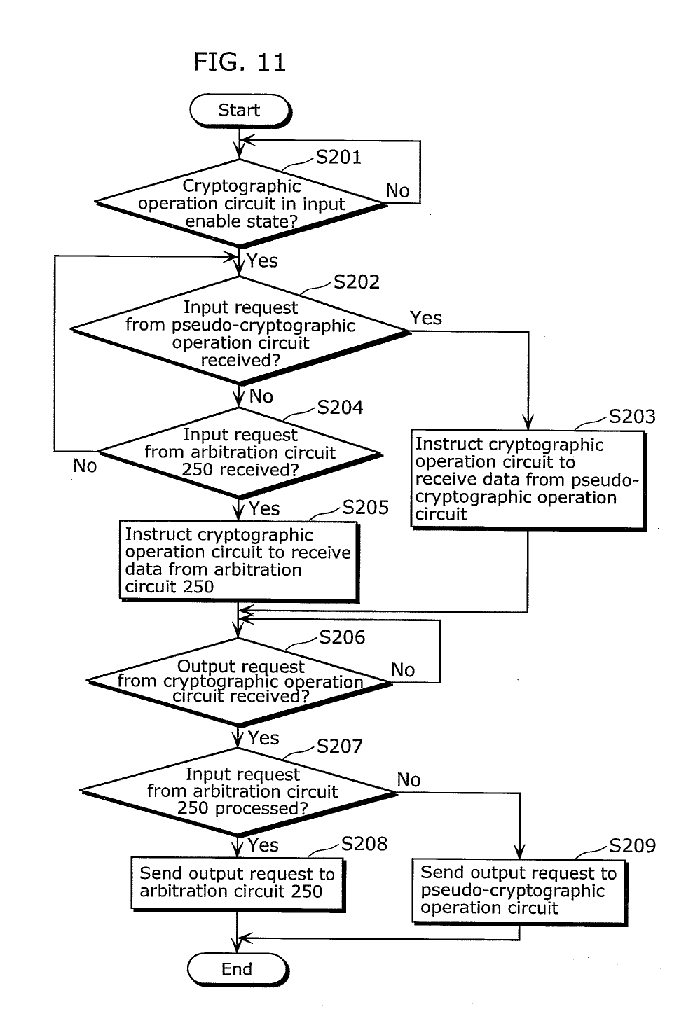

FIG. 11 is a flowchart showing a flow of processing of the arbitration circuit 260.

First, the arbitration circuit 260 judges whether or not the cryptographic operation circuit 273 is in an input enable state (Step S201). That is, the arbitration circuit 260 judges whether or not the cryptographic operation circuit 273 is in a state of being able to perform a cryptographic operation. When the cryptographic operation circuit 273 is currently performing a cryptographic operation and therefore is not in an input enable state (Step S201: No), the arbitration circuit 260 waits until the cryptographic operation circuit 273 changes to an input enable state.

When the cryptographic operation circuit 273 is in an input enable state (Step S201: Yes), the arbitration circuit 260 further judges whether or not an input request from the pseudo-cryptographic operation circuit 274 (i.e., an input request made to the pseudo-cryptographic operation circuit 274) is received (Step S202).

When the input request from the pseudo-cryptographic operation circuit 274 is received (Step S202: Yes), the arbitration circuit 260 instructs the cryptographic operation circuit 273 to receive input data outputted from the pseudo-cryptographic operation circuit 274 (Step S203). For example, the arbitration circuit 260 provides this instruction by outputting, to the cryptographic operation circuit 273, the input request made to the pseudo-cryptographic operation circuit 274.

When the input request from the pseudo-cryptographic operation circuit 274 is not received (Step S202: No), the arbitration circuit 260 judges whether or not an input request from the arbitration circuit 250 (i.e., an input request made to the cryptographic operation circuit 273) is received (Step S204).

When the input request from the arbitration circuit 250 is not received (Step S204: No), the arbitration circuit 260 judges again whether or not the input request from the pseudo-cryptographic operation circuit 274 is received, after a predetermined time (Step S202).

When the input request from the arbitration circuit 250 is received (Step S204: Yes), the arbitration circuit 260 instructs the cryptographic operation circuit 273 to receive input data outputted from the arbitration circuit 250 (Step S205). For example, the arbitration circuit 260 provides this instruction by outputting, to the cryptographic operation circuit 273, the input request made to the cryptographic operation circuit 273.

In other words, the arbitration circuit 260 accepts the input request from the pseudo-cryptographic operation circuit 274 when the cryptographic operation circuit 273 is in an input enable state, and accepts the input request from the arbitration circuit 250 when the cryptographic operation circuit 273 is in an input enable state and also there is no input request from the pseudo-cryptographic operation circuit 274.

Thus, the arbitration circuit 260 prioritizes the input request from the pseudo-cryptographic operation circuit 274, over the input request from the arbitration circuit 250.

After providing the instruction by outputting the input request to the cryptographic operation circuit 273 in Step S203 or S205, the arbitration circuit 260 judges whether or not an output request is received from the cryptographic operation circuit 273, at predetermined time intervals (Step S206). Which is to say, the arbitration circuit 260 waits until the cryptographic operation circuit 273 ends the cryptographic operation and outputs the output request.

When the output request is outputted from the cryptographic operation circuit 273 (Step S206: Yes), the arbitration circuit 260 judges whether or not the processed input request is the input request from the arbitration circuit 250 (Step S207). That is, the arbitration circuit 260 judges whether the processed input request is the input request from the arbitration circuit 250 or the input request from the pseudo-cryptographic operation circuit 274.

When the processed input request is the input request from the arbitration circuit 250 (Step S207: Yes), the arbitration circuit 260 outputs the output request to the arbitration circuit 250 (Step S208). When the processed input request is the input request from the pseudo-cryptographic operation circuit 274 (Step S207: No), the arbitration circuit 260 outputs the output request to the pseudo-cryptographic operation circuit 274 (Step S209).

According to the above operational procedure, the arbitration circuit 260 can instruct the cryptographic operation circuit 273 to perform a cryptographic operation using the second context 277 or 278, based on the input request made to the cryptographic operation circuit 273 received from the arbitration circuit 250 or the input request made to the pseudo-cryptographic operation circuit 274 received from the pseudo-cryptographic operation circuit 274. The arbitration circuit 260 can also instruct the cryptographic operation circuit 273 to perform the cryptographic operation on the input data outputted from the arbitration circuit 250 or the input data outputted from the pseudo-cryptographic operation circuit 274.

Moreover, the arbitration circuit 260 can output the output request and the output data generated as a result of the cryptographic operation by the cryptographic operation circuit 273, to one of the arbitration circuit 250 and the pseudo-cryptographic operation circuit 274 from which the arbitration circuit 260 receives the input request.

The detailed operational procedure of the cryptographic operation circuit 273 in Steps S105 and S106 shown in FIG. 9 is described next.

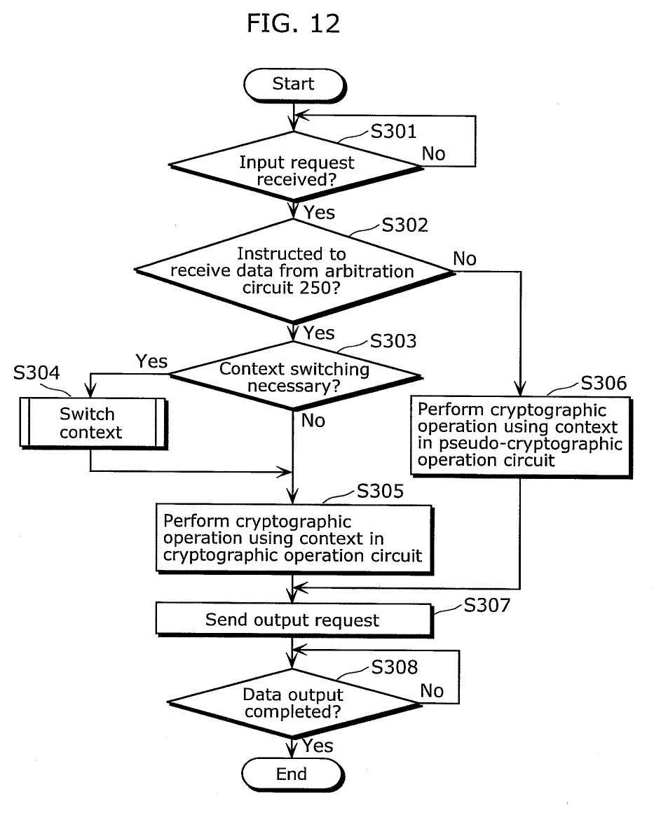

FIG. 12 is a flowchart showing a flow of processing of the cryptographic operation circuit 273.

First, the cryptographic operation circuit 273 judges whether or not an input request is received from the arbitration circuit 260 (Step S301). When the input request is received (Step S301: Yes), the control unit 308 judges whether or not the arbitration circuit 260 instructs to receive input data from the arbitration circuit 250 (Step S302).

When the arbitration circuit 260 instructs to receive input data from the arbitration circuit 250 (Step S302: Yes), that is, when the received input request is an input request made to the cryptographic operation circuit 273, the control unit 308 judges whether or not switching (saving and restoring) of the second context 277 is necessary (Step S303). Which is to say, the control unit 308 judges whether or not a second context corresponding to the input data is held in the context register 302. In more detail, the control unit 308 judges that the switching of the second context 277 is not necessary when a context ID included in the input request matches a context ID included in the second context 277 held in the context register 302, and judges that the switching of the second context 277 is necessary when the context ID included in the input request does not match the context ID included in the second context 277.

When the context switching is necessary (Step S303: Yes), the control unit 308 performs the context switching (Step S304). In detail, the control unit 308 causes the selector 305 to select a second context outputted from the context control circuit 240, and sends a context save and restore request to the context control circuit 240.

Upon receiving the context save and restore request, the context control circuit 240 saves the second context 277 held in the context register 302, into the context storage unit 230. That is, the context control circuit 240 reads the second context 277 held in the context register 302, and stores the read second context in the context storage unit 230.

The context control circuit 240 then restores the second context corresponding to the context ID included in the input request, which is stored in the context storage unit 230, into the context register 302. That is, the context control circuit 240 reads the second context 232 corresponding to the context ID included in the input request from the context storage unit 230, and stores the read second context in the context register 302.

When the context switching is not necessary (Step S303: No) or after the context switching is performed (Step S304), the control unit 308 causes the selector 304 to select the input data outputted from the arbitration circuit 250. As a result, the input data outputted from the arbitration circuit 250 is stored in the input register 301. Note here that the storage of the input data into the input register 301 may be performed before or at the same time as Steps S303 and S304.

The control unit 308 also causes the selector 306 to select the second context held in the context register 302, and the selector 307 to select the input data held in the input register 301. As a result, the input data held in the input register 301 and the second context 277 held in the context register 302 are inputted in the cryptographic operation core 303.

The cryptographic operation core 303 performs a cryptographic operation on the input data held in the input register 301, using the second context held in the context register 302 (Step S305). The control unit 308 further causes the selector 305 to select a second context outputted from the cryptographic operation core 303. Hence a second context generated by the cryptographic operation is stored in the context register 302.

Output data generated as a result of the cryptographic operation by the cryptographic operation core 303 is outputted to the arbitration circuit 250. In addition, the control unit 308 outputs an output request to the arbitration circuit 260 (Step S307).

After completing the output of the output data to the arbitration circuit 250 (Step S308: Yes), the cryptographic operation circuit 273 ends the cryptographic operation process for the input request received in Step S301.

On the other hand, when the arbitration circuit 260 instructs to receive input data from the pseudo-cryptographic operation circuit 274 (Step S302: No), that is, when the received input request is an input request made to the pseudo-cryptographic operation circuit 274, the control unit 308 causes the selector 306 to select the second context held in the context register 312, and the selector 307 to select the input data held in the input register 311. As a result, the input data held in the input register 311 and the second context 278 held in the context register 312 are inputted in the cryptographic operation core 303.

The cryptographic operation core 303 performs a cryptographic operation on the input data held in the input register 311, using the second context 278 held in the context register 312 (Step S306). The cryptographic operation core 303 outputs output data and a second context generated by the cryptographic operation, to the pseudo-cryptographic operation circuit 274. The control unit 308 outputs an output request to the arbitration circuit 260 (Step S307).

After completing the output of the output data to the pseudo-cryptographic operation circuit 274 (Step S308: Yes), the cryptographic operation circuit 273 ends the cryptographic operation process for the input request received in Step S301.

According to the above operational procedure, the cryptographic operation circuit 273 can perform a cryptographic operation on the input data from the arbitration circuit 250 using the second context 277 or a cryptographic operation on the input data from the pseudo-cryptographic operation circuit 274 using the second context 278, based on the instruction from the arbitration circuit 260.

Moreover, the cryptographic operation circuit 273 can output the output data as a result of the cryptographic operation, to the arbitration circuit 250 or the pseudo-cryptographic operation circuit 274.

Furthermore, the cryptographic operation circuit 273 can perform second context saving and restoring, when the second context corresponding to the input request is not held therein.

The detailed operational procedure of the pseudo-cryptographic operation circuit 274 in Steps S105 and S106 shown in FIG. 9 is described next.

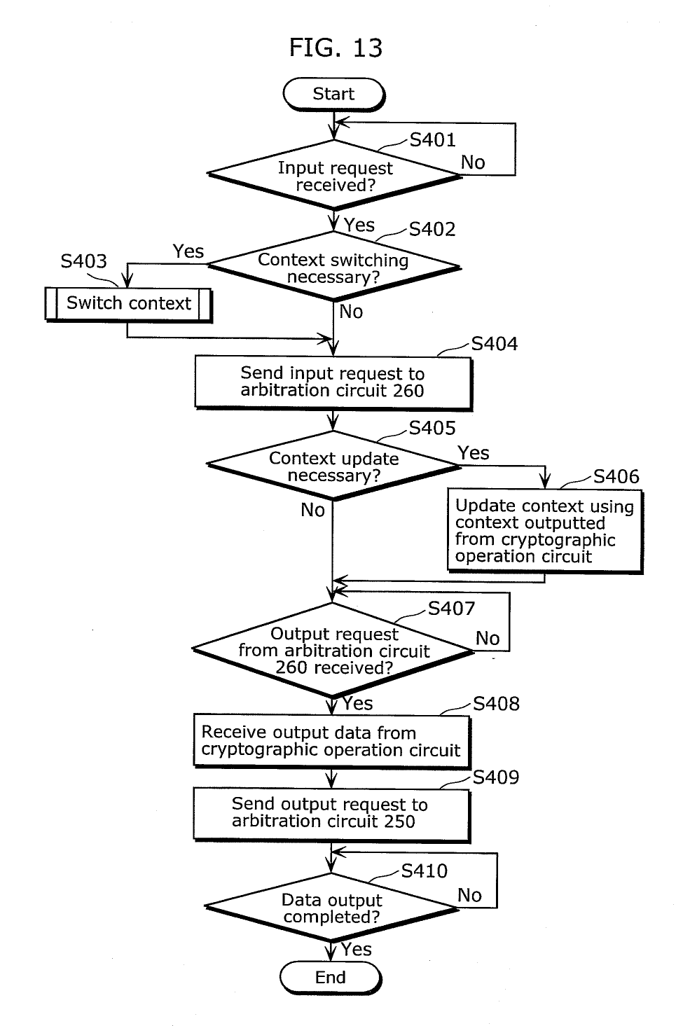

FIG. 13 is a flowchart showing a flow of processing of the pseudo-cryptographic operation circuit 274.

First, the pseudo-cryptographic operation circuit 274 judges whether or not an input request is received from the arbitration circuit 250 (Step S401). When the input request is received (Step S401: Yes), the control unit 318 judges whether or not context switching is necessary (Step S402). Which is to say, the control unit 318 judges whether or not a second context corresponding to input data is held in the context register 312. In more detail, the control unit 318 judges that the second context switching is unnecessary when a context ID included in the input request matches a context ID included in the second context 278 held in the context register 312, and judges that the second context switching is necessary when the context ID included in the input request does not match the context ID included in the second context 278.

When the context switching is necessary (Step S402: Yes), the control unit 318 performs the context switching (Step S403). In detail, the control unit 318 causes the selector 315 to select a second context outputted from the context control circuit 240, and sends a context save and restore request to the context control circuit 240.

Upon receiving the context save and restore request, the context control circuit 240 saves the second context 278 held in the context register 312, into the context storage unit 230. That is, the context control circuit 240 reads the second context 278 held in the context register 312, and stores the read second context in the context storage unit 230.

The context control circuit 240 then restores the second context corresponding to the context ID included in the input request, which is stored in the context storage unit 230, into the context register 312. That is, the context control circuit 240 reads the second context 232 corresponding to the context ID included in the input request from the context storage unit 230, and stores the read second context in the context register 312.

When the context switching is not necessary (Step S402: No) or after the context switching is performed (Step S403), the control unit 318 causes the selector 314 to select the input data outputted from the arbitration circuit 250. As a result, the input data outputted from the arbitration circuit 250 is stored in the input register 311. Note here that the storage of the input data into the input register 311 may be performed before or at the same time as Steps S402 and S403.

Next, the control unit 318 outputs the input request to the arbitration circuit 260 (Step S404). Note here that the output of the input request to the arbitration circuit 260 (Step S404) may be performed before or at the same time as Steps S402 and S403.

The arbitration circuit 260 outputs the input request received from the control unit 318, to the cryptographic operation circuit 273. The cryptographic operation circuit 273 accordingly performs a cryptographic operation on the input data held in the input register 311 in the pseudo-cryptographic operation circuit 274, using the second context 278.

After the cryptographic operation by the cryptographic operation core 303 ends, the control unit 318 judges whether or not the second context 278 held in the context register 312 needs to be updated (Step S405). That is, the control unit 318 judges whether or not an intermediate value, a chain value, or the like included in the second context is updated as a result of the cryptographic operation by the cryptographic operation core 303. When the update is necessary (Step S405: Yes), the control unit 318 causes the selector 315 to select the second context outputted from the cryptographic operation core 303. As a result, the second context held in the context register 312 is replaced with the second context outputted from the cryptographic operation core 303 (Step S406).

When the update is not necessary (Step S405: No) or after the update is performed (Step S406), the control unit 318 judges whether or not an output request is received from the arbitration circuit 260, at predetermined time intervals (Step S407). Thus, the control unit 318 waits until the output request is outputted from the arbitration circuit 260.

Upon receiving the output request from the arbitration circuit 260 (Step S407: Yes), the control unit 318 receives the output data generated as a result of the cryptographic operation by the cryptographic operation core 303, and stores the output data in the output register 313 (Step S408).

The control unit 318 then outputs the output request to the arbitration circuit 250 (Step S409).

Meanwhile, the output register 313 outputs the stored output data to the arbitration circuit 250. After completing the output of the output data to the arbitration circuit 250 (Step S410: Yes), the pseudo-cryptographic operation circuit 274 ends the cryptographic operation process for the input request received in Step S401.

According to the above operational procedure, the pseudo-cryptographic operation circuit 274 can output the output request and the output data generated as a result of the cryptographic operation by the cryptographic operation circuit 273, to the arbitration circuit 250.

Moreover, the pseudo-cryptographic operation circuit 274 can perform second context saving and restoring, when the second context corresponding to the input request is not held therein.

As described above, the confidential information processing apparatus 200 according to the embodiment of the present invention stores a plurality of second contexts which are each necessary for a different one of a plurality of cryptographic operations, in the context storage unit 230. Moreover, the second contexts 275 to 278 held in the cryptographic operation circuits 271, 272, and 273 and the pseudo-cryptographic operation circuit 274 can be saved into and restored from the context storage unit 230, by the context control circuit 240. Accordingly, each of the context registers 302, 312, and 322 only needs to hold at least one second context. Therefore, even when the number of sets of data that can be switched or the number of cryptographic operations that can be executed on one set of data is increased in the confidential information processing device 200, there is no need to increase the number of context registers. In other words, the confidential information processing device 200 can increase the number of sets of data that can be switched or the number of cryptographic operations that can be executed on one set of data, without an increase in register circuit area. Hence the confidential information processing device 200 can perform a cryptographic operation on a plurality of sets of data and also perform a plurality of cryptographic operations on one set of data, without an increase in circuit area.

Because the number of context registers needs to be determined in a stage prior to design of a confidential information processing device, it is not easy to change the number of context registers. In the confidential information processing device 200 according to the embodiment of the present invention, however, a plurality of second contexts are stored in the context storage unit 230 that is realized by a RAM, so that the number of second contexts can be changed after design. For instance, this can be done merely by changing an area for storing the second contexts 232 in a storage capacity of the RAM, by means of software control.

Moreover, the confidential information processing device 200 according to the embodiment of the present invention includes the plurality of stream analysis circuits 221, 222, and 223. Each of these stream analysis circuits 221, 222, and 223 performs an analysis according to a different first context. Therefore, the confidential information processing device 200 can perform analyses without performing first context switching, even when the data to be processed is different between the first cryptographic operation and the second cryptographic operation. As a result, the processing can be accelerated, and the control can be eased. This enables the confidential information processing device 200 to support various cryptographic modes. For example, in the confidential information processing device described in Patent Reference 1, the output result is directly feedback-inputted and also is used as a chain value, so that the operable mode is limited to Cipher Block Chain (CBC) or the like.

Furthermore, the confidential information processing device 200 priorities the second cryptographic operation over the first cryptographic operation. As a result, data for which the second cryptographic operation has been completed is outputted sequentially to outside, with it being possible to reduce the stored amount of data before the second cryptographic operation (that is, the stored amount of data for which the first cryptographic operation has been completed).

It should be noted that the above describes an example where two cryptographic operations according to AES are performed on one stream, but the confidential information processing device 200 according to the embodiment of the present invention can also perform one cryptographic operation according to AES on one stream. An operation procedure in this case is the same as that of the first or second operation described above, and so its explanation has been omitted here.

Moreover, the confidential information processing device 200 can perform a cryptographic operation according to DES or SHA on one stream. An operational procedure in this case is the same as in the case of performing a cryptographic operation according to AES, except that the cryptographic operation circuit which performs the cryptographic operation is different and the transfer of the input request and the output request via the arbitration circuit 260 is not performed.

In more detail, the arbitration circuit 250 references the cryptographic algorithm correspondence table 241 and determines that the cryptographic algorithm is DES or SHA (Step S103). The arbitration circuit 250 outputs input data extracted by the stream analysis circuit 221, 222, or 223 and an input request, to the cryptographic operation circuit 271 or 272.

The input request outputted from the arbitration circuit 250 here is an input request made to the cryptographic operation circuit 271 or 272 (Step S104: No). Accordingly, the cryptographic operation circuit 271 or 272 performs a cryptographic operation on the input data outputted from the arbitration circuit 250, using the second context 275 or 276 held in the context register 322 (Step S106). The cryptographic operation circuit 271 or 272 outputs output data generated as a result of the cryptographic operation and an output request, to the arbitration circuit 250.

The arbitration circuit 250 outputs the output data outputted from the cryptographic operation circuit 271 or 272, to the stream analysis circuit 221, 222, or 223 which is the source of the input request, according to the output request from the cryptographic operation circuit 271 or 272.

The stream analysis circuit 221, 222, or 223 incorporates the output data outputted from the arbitration circuit 250 into the original stream, and outputs the resulting stream to the stream control circuit 210 (Step S107).

The confidential information processing device 200 can also perform two cryptographic operations according to two different cryptographic algorithms out of AES, DES, and SHA, on one stream. An operational procedure in this case is the same as in the case of performing two cryptographic operations according to AES, except that the cryptographic operation circuit which performs the cryptographic operation is different.

Furthermore, in the confidential information processing device 200, the cryptographic operation circuit 273 performs a cryptographic operation using the second context 277 or 278 held in the context register 302 or 312. Accordingly, when switching between the first cryptographic process and the second cryptographic process, the saving and restoring of the second context 277 or 278 between the context storage unit 230 and the context register 302 or 312 does not need to be performed each time the input data which is subject to the cryptographic operation is switched. As a result, the number of times the information saving and restoring is performed can be reduced. Hence the confidential information processing device 200 can perform cryptographic operations at high speed.

A specific example of this is given below.

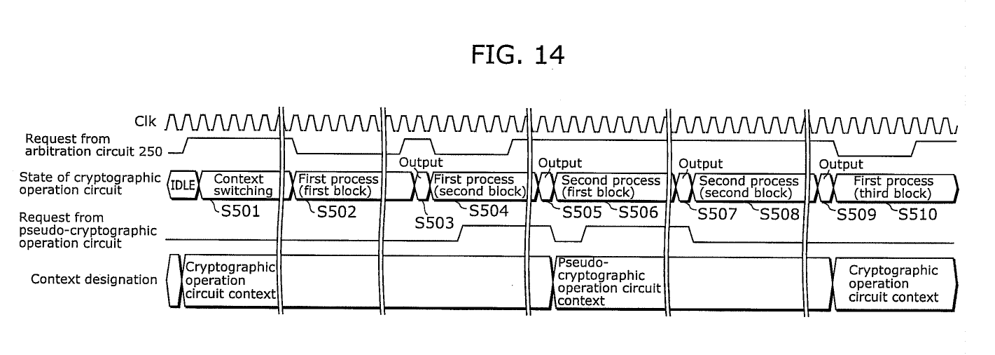

FIG. 14 shows a state of the cryptographic operation circuit 273 in two consecutive cryptographic operations according to AES on one stream, where the first cryptographic algorithm is AES and the second cryptographic algorithm is AES-DUMMY.

As shown in FIG. 14, the cryptographic operation circuit 273 first performs context switching to a second context corresponding to the first cryptographic operation (Step S501). The cryptographic operation circuit 273 then performs the first cryptographic operation (AES) on data of a first block in an input stream (Step S502). The cryptographic operation circuit 273 outputs the data of the first block on which the cryptographic operation has been performed in Step S502 (Step S503). Following this, the cryptographic operation circuit 273 performs the first cryptographic operation on data of a second block (Step S504), and outputs the data of the second block on which the cryptographic operation has been performed (Step S505). Next, the cryptographic operation circuit 273 performs the second cryptographic operation on the data of the first block outputted in Step S503 (Step S506), and outputs the data of the first block on which the cryptographic operation has been performed (Step S507). The cryptographic operation circuit 273 further performs the second cryptographic operation on the data of the second block outputted in Step S505 (Step S508), and outputs the data of the second block on which the cryptographic operation has been performed (Step S509). Following this, the cryptographic operation circuit 273 performs the first cryptographic operation on data of a third block (Step S510), and outputs the data of the third block on which the cryptographic operation has been performed. The cryptographic operation circuit 273 repeats the same processing for the subsequent blocks.

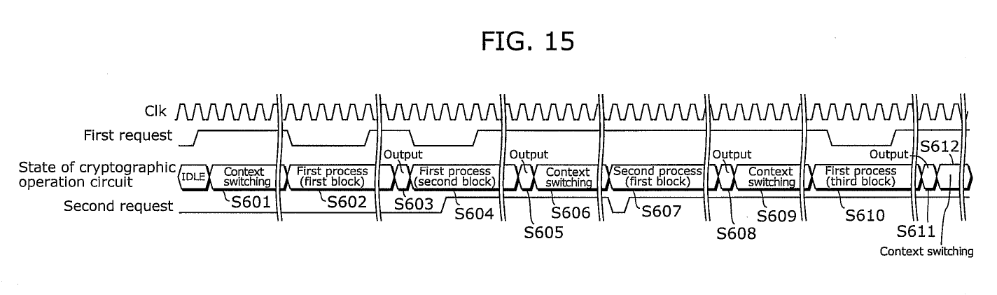

FIG. 15 shows a state of the cryptographic operation circuit 273, in the case where the confidential information processing device does not include the pseudo-cryptographic operation circuit 274 and the arbitration circuit 260.

As shown in FIG. 15, the cryptographic operation circuit 273 first performs context switching to a second context corresponding to the first cryptographic operation (Step S601). The cryptographic operation circuit 273 then performs the first cryptographic operation on data of a first block in an input stream (Step S602), and outputs the data of the first block on which the cryptographic operation has been performed (Step S603). Following this, the cryptographic operation circuit 273 performs the first cryptographic operation on data of a second block (Step S604), and outputs the data of the second block on which the cryptographic operation has been performed (Step S605). Next, the cryptographic operation circuit 273 performs context switching to a second context corresponding to the second cryptographic operation (Step S606). The cryptographic operation circuit 273 then performs the second cryptographic operation on the data of the first block outputted in Step S603 (Step S607), and outputs the data of the first block on which the cryptographic operation has been performed (Step S608). Next, the cryptographic operation circuit 273 again performs context switching to the second context corresponding to the first cryptographic operation (Step S609). The cryptographic operation circuit 273 then performs the first cryptographic operation on data of a third block (Step S610), and outputs the data of the third block on which the cryptographic operation has been performed (Step S611). The cryptographic operation circuit 273 repeats the same processing for the subsequent blocks.

Context switching frequently occurs in the case where the confidential information processing device does not include the pseudo-cryptographic operation circuit 274 and the arbitration circuit 260, as shown in FIG. 15. On the other hand, the context switching occurrence frequency can be reduced in the confidential information processing device 200 according to the embodiment of the present invention, as shown in FIG. 14.

The context switching occurrence frequency may also be reduced by providing a plurality of cryptographic operation circuits which execute a same cryptographic algorithm. However, since a cryptographic operation core included in a cryptographic operation circuit has a large circuit size, providing a plurality of cryptographic operation circuits of a same cryptographic algorithm causes another problem, that is, an increase in area of the confidential information processing device.

In the confidential information processing device 200, on the other hand, the pseudo-cryptographic operation circuit 274 does not have a cryptographic operation core for performing a cryptographic operation. Hence the confidential information processing device 200 according to the embodiment of the present invention can reduce the context switching occurrence frequency without an increase in circuit area.

The above describes the case where one stream is inputted, but the confidential information processing device 200 according to the embodiment of the present invention can also perform a cryptographic operation while switching data in the case where a plurality of streams are inputted in a congestion state.

Furthermore, when the plurality of streams inputted in a congestion state are subject to cryptographic operations according to AES using different contexts, the same effect as the above case of performing two cryptographic operations according to AES on one stream can be achieved. For example, when a first stream and a second stream are inputted in a congestion state, “first cryptographic operation” and “second cryptographic operation” in the above description can be replaced with “first stream” and “second stream”, respectively. That is, the confidential information processing device 200 can reduce the context switching occurrence frequency, in the case of switching a cryptographic operation according to a same cryptographic algorithm between two streams.

Although the confidential information processing device according to the embodiment of the present invention has been described above, the present invention is not limited to the above embodiment.

For instance, the above embodiment describes an example where the confidential information processing device 200 includes the three cryptographic operation circuits 271, 272, and 273, but the number of cryptographic operation circuits should not be limited to such. The confidential information processing device 200 may include only the cryptographic operation circuit 273, or include two cryptographic operation circuits or at least four cryptographic operation circuits.

The above embodiment describes the case where the confidential information processing device 200 includes one pseudo-cryptographic operation circuit 274, but the confidential information processing device 200 may include a plurality of pseudo-cryptographic operation circuits of a same cryptographic algorithm. This makes it possible to perform three or more cryptographic operations of a predetermined cryptographic algorithm on one stream. In the case of performing n cryptographic operations (n being a given natural number), it is desirable to provide (n-1) pseudo-cryptographic operation circuits of the predetermined cryptographic algorithm. In this case, the arbitration circuit 260 arbitrates input requests made to the cryptographic operation circuit 273 and the (n-1) pseudo-cryptographic operation circuits that correspond to the cryptographic operation circuit 273.

The above embodiment describes the case where the cryptographic algorithm of the cryptographic operation circuit 273 corresponding to the pseudo-cryptographic operation circuit 274 is AES. However, this is merely one example, and other cryptographic algorithms are equally applicable.

The above embodiment describes the case where the confidential information processing device 200 includes only the pseudo-cryptographic processing circuit 274 corresponding to the cryptographic operation circuit 273. However, the confidential information processing device 200 may also include a pseudo-cryptographic processing circuit corresponding to at least one of the cryptographic operation circuits 271 and 272 and an arbitration circuit, having the same structure as the arbitration circuit 260, for arbitrating input requests made to these cryptographic operation circuit and pseudo-cryptographic operation circuit.

The above embodiment describes the case where the cryptographic algorithms of the cryptographic operation circuits are AES, DES, and SHA, but other cryptographic algorithms such as MULTI2, Camellia, and Message Digest 5 (MD5) are applicable, too.

In addition, the mode of cryptographic operation performed in each cryptographic operation circuit may be an arbitrary mode such as CBC, Electronic Code Block (ECB), X-CBC-MAC, Output Feedback (OFB), and Counter (CTR).

The above embodiment describes the case where the confidential information processing device 200 includes the three stream analysis circuits 221, 222, and 223. Alternatively, the confidential information processing device 200 may include one stream analysis circuit, two stream analysis circuits, or at least four stream analysis circuits.

The above embodiment describes the case where the designated cryptographic algorithm (AES or AES-DUMMY) is used to determine whether a cryptographic operation is assigned to the cryptographic operation circuit 273 or the pseudo-cryptographic operation circuit 274. As an alternative, the arbitration circuit 250 may automatically assign a cryptographic operation to either the cryptographic operation circuit 273 or the pseudo-cryptographic operation circuit 274.

The above embodiment describes the case where the stream control circuit 210 stores the context correspondence table 211, but the context storage unit 230 or the like may store the context corresponding table 211. In this case, the stream control circuit 210 performs the above process, by referencing the context correspondence table 211 stored in the context storage unit 230.

The above embodiment describes the case where the context control circuit 240 stores the cryptographic algorithm correspondence table 241, but the context storage unit 230 or the like may store the cryptographic algorithm correspondence table 241. In this case, the context storage unit 230 may store the first context 231, the second context 232, and the information included in the cryptographic algorithm correspondence table 241 as one context which is associated with one context ID.

The above embodiment describes the case where the confidential information processing device 200 performs encryption and decryption, but the confidential information processing device 200 may instead perform only one of encryption and decryption.

The above embodiment describes an example where the confidential information processing device 200 is applied to a mobile phone. However, the confidential information processing device 200 can equally be applied to a digital television, an STB, a DVD recorder, a DVD player, an HD recorder, a PC, a Personal Digital Assistant (PDA), and the like.

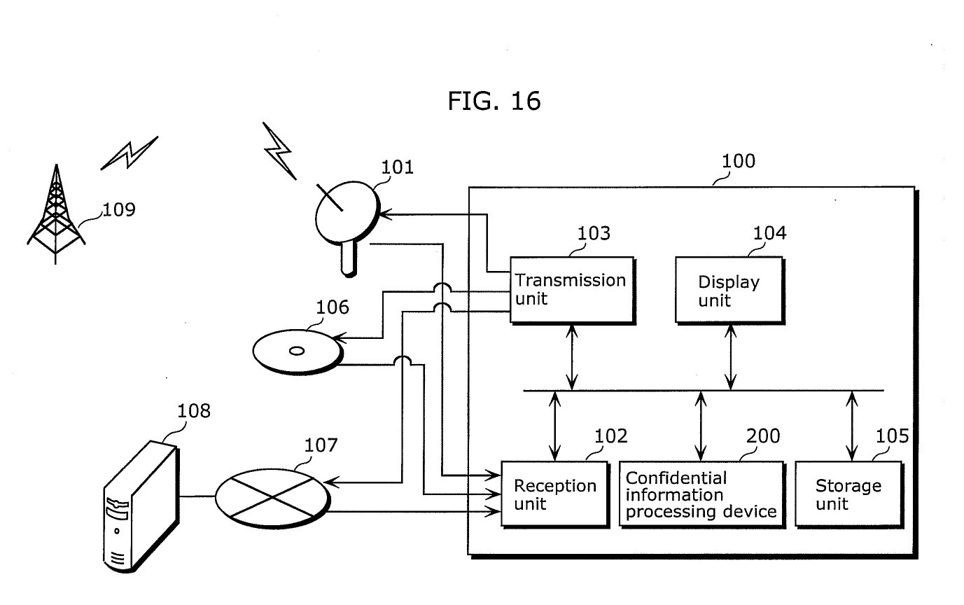

FIG. 16 shows a structure of a variation of the confidential information processing apparatus 100 according to the embodiment of the present invention. As shown in FIG. 16, the confidential information processing apparatus 100 may decrypt ciphertext data transmitted from an external apparatus 109 by digital broadcasting or the like, and display the decrypted data on the display unit 104. The confidential information processing apparatus 100 may also decrypt ciphertext data stored on a recording medium (such as a CD, a DVD, a memory card, and a USB memory) 106. The confidential information processing apparatus 100 may also store data encrypted by the confidential information processing device 200, on the recording medium 106. The confidential information processing apparatus 100 may also decrypt ciphertext data transmitted from an external apparatus 108 via a network 107. The confidential information processing apparatus 100 may also transmit data encrypted by the confidential information processing device 200, to the external apparatus 108 via the network 107.

The present invention can be applied to a confidential information processing device, and especially to a confidential information processing apparatus connected to a network that requires cryptographic communication and a confidential information processing apparatus for processing a copyright-protected stream. For example, the present invention is applicable to a mobile phone, a digital television, an STB, a DVD recorder, a DVD player, an HD recorder, a PC, a PDA, and the like.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. A confidential information processing device that performs a cryptographic operation on first input data and second input data, said confidential information processing device comprising:
a first cryptographic operation circuit;
a first pseudo-cryptographic operation circuit; and
a first arbitration circuit that arbitrates cryptographic operation requests made to said first cryptographic operation circuit and said first pseudo-cryptographic operation circuit,
wherein said first cryptographic operation circuit includes:
a first register that holds first information necessary for performing the cryptographic operation on the first input data; and
a first cryptographic operation unit configured to perform the cryptographic operation,
said first pseudo-cryptographic operation circuit includes
a second register that holds second information necessary for performing the cryptographic operation on the second input data,
said confidential information processing device further comprises:
a storage unit configured to hold the first information and the second information; and
a control circuit that writes the first information and the second information held in said storage unit respectively into said first register and said second register, and saves the first information and the second information respectively held in said first register and said second register into said storage unit, and
said first arbitration circuit:
causes said first cryptographic operation unit to perform the cryptographic operation on the first input data using the first information held in said first register, when a cryptographic operation request for the first input data is made to said first cryptographic operation circuit; and
causes said first cryptographic operation unit to perform the cryptographic operation on the second input data using the second information held in said second register, when a cryptographic operation request for the second input data is made to said first pseudo-cryptographic operation circuit.

2. The confidential information processing device according to claim 1,
wherein the first information includes at least one of a key, an initial value, and intermediate information of the cryptographic operation of the first input data, and
the second information includes at least one of a key, an initial value, and intermediate information of the cryptographic operation of the second input data.

3. The confidential information processing device according to claim 1,
wherein said control circuit:
saves information held in said first register into said storage unit and writes the first information held in said storage unit into said first register, when the cryptographic operation request for the first input data is made to said first cryptographic operation circuit and the first information is not held in said first register; and
saves information held in said second register into said storage unit and writes the second information held in said storage unit into said second register, when the cryptographic operation request for the second input data is made to said first pseudo-cryptographic operation circuit and the second information is not held in said second register.

4. The confidential information processing device according to claim 1, further comprising:
a first analysis circuit that extracts the first input data from a first stream, and incorporates first output data into the first stream, the first output data being a result of the cryptographic operation performed on the first input data by said first cryptographic operation unit; and
a second analysis circuit that extracts the second input data from a second stream, and incorporates second output data into the second stream, the second output data being a result of the cryptographic operation performed on the second input data by said first cryptographic operation unit,
wherein said first cryptographic operation unit is configured to perform the cryptographic operation on the first input data extracted by said first analysis circuit, using the first information held in said first register, and perform the cryptographic operation on the second input data extracted by said second analysis circuit, using the second information held in said second register.

5. The confidential information processing device according to claim 1,
wherein the second input data is a result of the cryptographic operation performed on the first input data by said first cryptographic operation unit, and
said first arbitration circuit causes said first cryptographic operation unit to perform the cryptographic operation on the first input data using the first information held in said first register, and subsequently causes said first cryptographic operation unit to perform the cryptographic operation on the second input data using the second information held in said second register.

6. The confidential information processing device according to claim 5, further comprising:
a first analysis circuit that extracts the first input data from a first stream, and incorporates first output data into the first stream, the first output data being a result of the cryptographic operation performed on the first input data by said first cryptographic operation unit; and
a second analysis circuit that extracts the second input data from the first stream in which the first output data has been incorporated by said first analysis circuit, and incorporates second output data into the first stream, the second output data being a result of the cryptographic operation performed on the second input data by said first cryptographic operation unit.

7. The confidential information processing device according to claim 5,
wherein said first arbitration circuit, when simultaneously receiving the cryptographic operation request made to said first cryptographic operation circuit and the cryptographic operation request made to said first pseudo-cryptographic operation circuit, causes said first cryptographic operation unit to perform the cryptographic operation on the second input data using the second information held in said second register.

8. The confidential information processing device according to claim 1, further performing a cryptographic operation of a different algorithm on third input data, said confidential information processing device further comprising
a second cryptographic operation circuit,
wherein said second cryptographic operation circuit includes:
a third register that holds third information necessary for performing the cryptographic operation on the third input data; and
a second cryptographic operation unit configured to perform the cryptographic operation of the different algorithm from the cryptographic operation performed by said first cryptographic operation unit,
said confidential information processing device further comprises
a second arbitration circuit that arbitrates cryptographic operation requests made to said first cryptographic operation circuit, said first pseudo-cryptographic operation circuit, and said second cryptographic operation circuit, and sends the cryptographic operation requests made to said first cryptographic operation circuit and said first pseudo-cryptographic operation circuit, to said first arbitration circuit, and
said first arbitration circuit:
causes said first cryptographic operation unit to perform the cryptographic operation on the first input data using the first information held in said first register, when the cryptographic operation request for the first input data made to said first cryptographic operation circuit is sent from said second arbitration circuit; and
causes said first cryptographic operation unit to perform the cryptographic operation on the second input data using the second information held in said second register, when the cryptographic operation request for the second input data made to said first pseudo-cryptographic operation circuit is sent from said second arbitration circuit.

9. The confidential information processing device according to claim 8, further performing the cryptographic operation of the different algorithm on fourth input data, said confidential information processing device further comprising:
a second pseudo-cryptographic operation circuit; and
a third arbitration circuit that arbitrates cryptographic operation requests made to said second cryptographic operation circuit and said second pseudo-cryptographic operation circuit,
wherein said second pseudo-cryptographic operation circuit includes
a fourth register that holds fourth information necessary for performing the cryptographic operation on the fourth input data, and
said third arbitration circuit:
causes said second cryptographic operation unit to perform the cryptographic operation on the third input data using the third information held in said third register, when a cryptographic operation request for the third input data is made to said second cryptographic operation circuit; and
causes said second cryptographic operation unit to perform the cryptographic operation on the fourth input data using the fourth information held in said fourth register, when a cryptographic operation request for the fourth input data is made to said second pseudo-cryptographic operation circuit.

10. The confidential information processing device according to claim 1,
wherein the cryptographic operation is a cryptographic operation of a secret key cryptographic algorithm.

11. A confidential information processing apparatus comprising:
a reception unit configured to receive first input data and second input data from an external apparatus; and
a confidential information processing device that performs a cryptographic operation on the first input data and the second input data,
wherein said confidential information processing device includes:
a first cryptographic operation circuit;
a first pseudo-cryptographic operation circuit; and
a first arbitration circuit that arbitrates cryptographic operation requests made to said first cryptographic operation circuit and said first pseudo-cryptographic operation circuit,
said first cryptographic operation circuit includes:
a first register that holds first information necessary for performing the cryptographic operation on the first input data; and
a first cryptographic operation unit configured to perform the cryptographic operation,
said first pseudo-cryptographic operation circuit includes a second register that holds second information necessary for performing the cryptographic operation on the second input data,
said confidential information processing device further includes:
a storage unit configured to hold the first information and the second information; and
a control circuit that writes the first information and the second information held in said storage unit respectively into said first register and said second register, and saves the first information and the second information respectively held in said first register and said second register into said storage unit,
said first arbitration circuit:
causes said first cryptographic operation unit to perform the cryptographic operation on the first input data using the first information held in said first register, when a cryptographic operation request for the first input data is made to said first cryptographic operation circuit; and
causes said first cryptographic operation unit to perform the cryptographic operation on the second input data using the second information held in said second register, when a cryptographic operation request for the second input data is made to said first pseudo-cryptographic operation circuit, and
said confidential information processing apparatus further comprises
a display unit configured to display first output data and second output data, the first output data being a result of the cryptographic operation performed on the first input data by said first cryptographic operation unit, and the second output data being a result of the cryptographic operation performed on the second input data by said first cryptographic operation unit.

12. A confidential information processing apparatus comprising
a confidential information processing device that performs a cryptographic operation on first input data and second input data,
wherein said confidential information processing device includes:
a first cryptographic operation circuit;
a first pseudo-cryptographic operation circuit; and
a first arbitration circuit that arbitrates cryptographic operation requests made to said first cryptographic operation circuit and said first pseudo-cryptographic operation circuit,
said first cryptographic operation circuit includes:
a first register that holds first information necessary for performing the cryptographic operation on the first input data; and
a first cryptographic operation unit configured to perform the cryptographic operation,
said first pseudo-cryptographic operation circuit includes
a second register that holds second information necessary for performing the cryptographic operation on the second input data,
said confidential information processing device further includes:
a storage unit configured to hold the first information and the second information; and
a control circuit that writes the first information and the second information held in said storage unit respectively into said first register and said second register, and saves the first information and the second information respectively held in said first register and said second register into said storage unit,
said first arbitration circuit:
causes said first cryptographic operation unit to perform the cryptographic operation on the first input data using the first information held in said first register, when a cryptographic operation request for the first input data is made to said first cryptographic operation circuit; and
causes said first cryptographic operation unit to perform the cryptographic operation on the second input data using the second information held in said second register, when a cryptographic operation request for the second input data is made to said first pseudo-cryptographic operation circuit, and
said confidential information processing apparatus further comprises
a transmission unit configured to transmit first output data and second output data to an external apparatus, the first output data being a result of the cryptographic operation performed on the first input data by said first cryptographic operation unit, and the second output data being a result of the cryptographic operation performed on the second input data by said first cryptographic operation unit.

13. A confidential information processing method in a confidential information processing device that performs a cryptographic operation on first input data and second input data,
wherein the confidential information processing device includes:
a first cryptographic operation circuit;
a first pseudo-cryptographic operation circuit; and
a first arbitration circuit that arbitrates cryptographic operation requests made to the first cryptographic operation circuit and the first pseudo-cryptographic operation circuit,
the first cryptographic operation circuit includes:
a first register that holds first information necessary for performing the cryptographic operation on the first input data; and
a first cryptographic operation unit configured to perform the cryptographic operation,
the first pseudo-cryptographic operation circuit includes
a second register that holds second information necessary for performing the cryptographic operation on the second input data,
the confidential information processing device further includes:
a storage unit configured to hold the first information and the second information; and
a control circuit that writes the first information and the second information held in the storage unit respectively into the first register and the second register, and saves the first information and the second information respectively held in the first register and the second register into the storage unit, and
said confidential information processing method comprises:
causing, by the first arbitration circuit, the first cryptographic operation unit to perform the cryptographic operation on the first input data using the first information held in the first register, when a cryptographic operation request for the first input data is made to the first cryptographic operation circuit; and
causing, by the first arbitration circuit, the first cryptographic operation unit to perform the cryptographic operation on the second input data using the second information held in the second register, when a cryptographic operation request for the second input data is made to the first pseudo-cryptographic operation circuit.
